(19) United States
(12) Patent Application Publication
(10) Pub. No.: US 2024/0320291 A1
(43) Pub. Date: Sep. 26, 2024

(54) Processes for Determining Values of Industrial Variables Using First and Second-Order Partial Derivatives

(71) Applicant: ExxonMobil Technology and Engineering Company, Baytown, TX (US)

(72) Inventors: Jon E. Haik, Humble, TX (US); Gangadhar Gattu, Sugarland, TX (US)

(21) Appl. No.: 18/588,126

(22) Filed: Feb. 27, 2024

Related U.S. Application Data
(60) Provisional application No. 63/491,579, filed on Mar. 22, 2023.

(51) Int. Cl. G06F 17/13; G06F 17/16; G06F 17/18

(52) U.S. Cl. CPC G06F 17/13; G06F 17/16; G06F 17/18

(57) ABSTRACT

Linear programming models utilizing first-order partial derivatives and at least one of cross-term partial derivatives and square-term partial derivatives are disclosed. The models can be more advantageous than models utilizing first-order partial derivatives only and models utilizing regressed coefficients. Effective, accurate, and efficient prediction and optimization of industrial processes, systems, and products can be achieved using the improved models.

### CROSS-REFERENCE TO RELATED APPLICATION

This application claims priority to and the benefit of U.S. Provisional Application No. 63/491,579 having a filing date of Mar. 22, 2023, the disclosure of which is incorporated herein by reference in its entirety.

### TECHNICAL FIELD

This disclosure relates to processes for determining values of output variables of industrial systems, processes and products dependent on one or more of input values, and processes for optimizing industrial systems, processes, and products. In particular, this disclosure relates to such processes using first-order partial derivatives and at least one of the cross-term and square-term partial derivatives. The processes of this disclosure can be useful, e.g., for predicting and optimizing the performances and attributes of industrial systems, processes, and products, especially those involving large numbers of input variables.

### BACKGROUND

Industrial systems and processes for producing industrial products, such as petrochemical plants, petroleum refineries, processes for producing petrochemical products such as olefins, and processes for refining crude oil, can be very complex, involving multiple interrelated system units and process steps, each having multiple independent and dependent factors (“input variables”) affecting in a non-linear fashion the operation of the overall system, process, and the final products produced. It would be highly desirable to understand, adjust, control, and optimize valuable attributes (“output variables”) of the industrial systems, processes, and products, that vary as a function of the input variables. If the total number of input variables is small, a limited number of well-designed experiments and trials may be effectively used for that purpose. However, as the total number of input variables increases, the total number of experiments and trials required can quickly increase to a very large number that is clearly infeasible. Thus for large and complex industrial systems and processes involving large numbers of input variables, more cost-effective modelling, simulation, and optimization tools have been used in lieu of experiments and trials for that purpose. Two classes of models have been developed: first-principles reference tools and derived tools.

First-principles reference tools are models that are based on first-principles i.e., mathematical relationships or logic that utilize accepted scientific theories or laws, such as those regarding chemical thermodynamics and/or kinetics. Such tools typically possess the capability to separately model the individual system units and process steps. First-principles reference tools typically contain a library of thermodynamic information relating to the behavior of different molecules, components, or pseudo-components in these units and steps. These tools can be used to create a model of individual system units and process steps by using the thermodynamic library, which can be further utilized to model sections and facilities including multiple connected units, and complex processes including multiple steps. For example, such a model can then directly provide heat and material balance information, which can be used for design, equipment rating, equipment performance, simulation, and optimization of an industry facility or process with various levels of complexities. Examples of commercially-available first-principles reference tools for petrochemical systems and processes include HYSIS® and Aspen Plus@, which are products of Aspen Technologies Incorporated of Cambridge, Mass.; PRO/II®, which is a product of SimSci-Esscor, an operating unit of Invensys plc of Cheshire, United Kingdom; and SPYRO®, which is a product of Technip-Coflexip SA of Paris, France. Recently, a new generation of first-principles reference tools has been developed for modeling, solving, and optimizing an entire process facility. Examples of these new reference tools are AspenTech RT-OPT®, which is a product of Aspen Technologies Incorporated of Cambridge, Mass., and SimSci ROMeo®, which is a product of SimSci-Esscor, an operating unit of Invensys plc, of Cheshire, United Kingdom. These tools are capable of solving very large simulation or optimization problems, usually via a non-linear simultaneous equation solver and/or optimizer. However, simulating complicated industrial systems and processes involving a large number of input variables using first principles-reference tools only can consume very significant computing resources, can take excessively long computing time, and thus can be prohibitively inefficient and expensive.

Derived tools require less computing power and time than do first-principles tools to solve a problem of similar size and complexity. Derived tools possess very convenient structures, albeit simplified, to depict many or all of the process unit operations needed to model a process facility. These derived tools can also have convenient report writing capabilities, and may possess various analysis tools for placing the modeling results in a form that can be more readily implemented. Derived tools can use either linear programming (“LP”) or sequential linear programming (“SLP”) type mathematics to solve optimization problems. Derived tools do not have the capability to model process unit operations based on first-principles, nor do they contain a thermodynamic library. Consequently, these derived tools cannot directly provide heat and material balance information for use in design, equipment rating, equipment performance, simulation, and optimization of the facility. Instead, a derived tool model typically utilizes information about the facility that has been obtained from (i) one or more of the first-principles tools (e.g., HYSIS®, Aspen Plus@, PRO/II®, and SPYRO®, referred to above), and/or (ii) other commercially available engineering tools that would be well known to persons skilled in the art of modeling industrial process facilities. This information is then imported into the derived tool. Nevertheless, given convenient form and analysis capabilities, as well as the computing advantages of LP or SLP programming, derived tools found use in operational planning, feedstock selection, and optimization of manufacturing facilities. Examples of commercially available derived tools include AspenTech PIMS®, which is a product of Aspen Technology Incorporated of Cambridge, Mass., and SimSci Petro®, which is a product of SimSci-Esscor, an operating unit of Invensys plc., of Cheshire, United Kingdom. More recently, models based on a combination of first-principles reference tools and derived tools have been developed for large process facilities. Such models typically treat a large processing facility as two or more facilities, where each facility is broken into two or more separate models of individual process units and interconnected to represent the overall facility. For example, U.S. Pat. No. 7,257,451 discloses a method for creating an LP model of an industrial process facility from a first-principles reference tool to interactively simulate and/or optimize the operation of the facility to facilitate or optimize feedstock selection and/or economic analyses based on varying prices, availabilities, and other external constraints.

However, the previously developed derived tools have various drawbacks, e.g., insufficient accuracy or accuracy consistency across a range of conditions to be simulated. As such, there is a need for improved methods and tools for simulating/modeling complicated industrial processes, systems, and products.

### SUMMARY

It has been found that, an LP model taking into consideration of, in addition to first-order partial derivatives of the output variables as a function of the input variables, at least one of square-term partial derivatives and cross-term derivatives, more accurate simulation of non-linear industrial system, process, and product can be achieved without significantly increasing the need for computation intensity. A thus-built non-linear model can then be reliably used to determine the values of desirable output variables at a given set of input variable values. The LP model can be particularly useful for optimizing industrial systems, processes and products, particularly the large ones involving many system units, process steps, and product parameters, such as an olefins production plant including a steam cracking unit and an olefins product recovery section, or a petroleum refinery including one or more reactors, multiple distillation columns, and other equipment.

Thus, a first aspect of this disclosure relates to a process for approximately determining the value of one or more of m output variables Yₖ of an industrial system, an industrial process, and/or an industrial product with a non-linear behavior as a function of n input variables Xᵢ, wherein i, m, and n are independently each a positive integer, 1≤k≤m, 1≤i≤n.

The process can comprise a step (I) of selecting a base point having a predetermined value of X_{i(base)} for each input variable Xᵢ.

The process can comprise a step (II) of obtaining an output value of Y_{k(base)} at the base point from the predetermined values of X_{i(base)} by using a non-linear reference tool.

The process can further comprise (III) of obtaining a first-order partial derivative, A_{i,k}, of Yₖ with respect to an Xᵢ at the base point, where

$${A}_{i , k} = \frac{\partial {Y}_{k}}{\partial {X}_{i}} . \qquad ( Equation - 1 )$$

The process can further comprise (IV) where n≥2, optionally obtaining a cross-term partial derivative, derivative, C_{p,q,k}, of Yₖ with respect to a pair of two input variables Xᵢ at the base point, where

$${C}_{p , q , k} = \frac{\partial \frac{\partial {Y}_{k}}{\partial {X}_{p}}}{\partial {X}_{q}} = \frac{\frac{\partial {Y}_{k}}{\partial {X}_{p ( base + h )}} - \frac{\partial {Y}_{k}}{\partial {X}_{p ( base )}}}{{X}_{q ( base + h )} - {X}_{q ( base )}} ; \qquad ( Equation - 2 )$$

where:
Xₚ and X_{q} are the pair of two input variables Xᵢ, p and q are positive integers, p≤n, q≤n;
X_{p(base+h)} is value of Xₚ at an alternative point differing from the base point, preferably in the vicinity of the base point;
X_{q(base+h)} is value of X_{q} at an alternative point differing from the base point, preferably in the vicinity of the base point;

$$\frac{\partial {Y}_{k}}{\partial {X}_{p ( base + h )}}$$

is first-order partial derivative of Yₖ with respect to Xₚ at a deviation point differing from the base point, preferably in the vicinity of the bae point; and
∂Yₖ/∂X_{p(base)} is first-order partial derivative of Yₖ with respect to Xₚ at the base point;

The process can comprise (V) optionally obtaining a square-term partial derivative, S_{r,k}, of Yₖ with respect to an input variable Xᵣ, at the base point, where:

$${S}_{r , k} = \frac{{\partial }^{2} {X}_{r}}{\partial {X}_{r}^{2}} = \frac{\frac{\partial {Y}_{k}}{\partial {X}_{r ( base + h )}} - \frac{\partial {Y}_{k}}{\partial {X}_{r ( base )}}}{2 \times ( {X}_{r ( base + h )} - {X}_{r ( base )} )} ; \qquad ( Equation - 3 )$$

where:
r is a positive integer, and 1≤r≤n;
X_{r(base+h)} is value of Xₚ at an alternative point differing from the base point, preferably in the vicinity of the base point;

$$\frac{\partial {Y}_{k}}{\partial {X}_{r ( base + h )}}$$

is first-order partial derivative of Yₖ with respect to Xᵣ at the alternative point; and

The process can further comprise (VI) calculating the value of Yₖ according to the following:
(VI.1) where n=1, and step (V) is carried out:

$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + Z 0 ; \qquad ( Equation - 4 a )$$

and
(VI.2) where n≥2, and
(VI.2a) where step (IV) is carried out and step (V) is optionally carried out:

$${Y}_{k} = {Y}_{k ( base )} + {\sum }_{i = 1}^{u} {A}_{i , k} \times ( {X}_{i} - {X}_{i ( base )} ) + {\sum }_{p = 1}^{v - 1} ( {\sum }_{q = p + 1}^{v} {C}_{p , q , k} \times ( {X}_{p} - {X}_{p ( base )} ) \times ( {X}_{q} - {X}_{q ( base )} ) ) + Z 0 ; \qquad ( Equation - 4 b \text{.1} )$$

or
(VI.2b) where step (IV) is optionally carried out and step (V) is carried out:

$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + Z 0 ; \qquad ( Equation - 4 b \text{.2} )$$

or
(VI.2c) where both step (IV) and step (V) are carried out:

$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + {\sum }_{p = 1}^{v - 1} ( {\sum }_{q = p + 1}^{v} {C}_{p , q , k} \times ( {X}_{p} - {X}_{p ( base )} ) \times ( {X}_{q} - {X}_{q ( base )} ) ) + Z 0 ; \qquad ( Equation - 4 b \text{.3} )$$

where u, v, and w are positive integers, u≤n, v≤n; and w≤n, and Z0 is a constant.

A second aspect of this disclosure is related to a process for optimizing an industrial system, an industrial process, and/or an industrial product with a non-linear behavior having one or more of m output variable Yₖ as a function of n input variables Xᵢ, where i, m, and n are each independently a positive integer, 1≤k≤m, 1≤i≤n. The process can comprise (A) determining a first set of value of one or more of Yₖ at a first set of Xᵢ by utilizing the process of the first aspect as summarily described above. The process can comprise a step (B) optimizing the industrial system, the industrial process, and/or the industrial product based at least partly on the first set of value of one or more of Yₖ.

The step (A) can comprise (A-I) selecting a base point having a predetermined value of X_{i(base)} for each input variable Xᵢ.

The step (A) can comprise (A-II) obtaining an output value of Y_{k(base)} from the predetermined values of X_{i(base)} by using a non-linear reference tool;

The step (A) can comprise (A-III) obtaining a first-order partial derivative, A_{i,k}, of Yₖ with respect to an Xᵢ at the base point, where

$${A}_{i , k} = \frac{\partial {Y}_{k}}{\partial {X}_{i}} ; \qquad ( Equation - 1 )$$

The step (A) can comprise (A-IV) obtaining a cross-term partial derivative, C_{p,q,k}, of Yₖ with respect to a pair of two input variables Xᵢ at the base point, obtainable by using the non-linear reference tool, where

$${C}_{p , q , k} = \frac{\partial \frac{\partial {Y}_{k}}{\partial {X}_{p}}}{\partial {X}_{q}} = \frac{\frac{\partial {Y}_{k}}{\partial {X}_{p ( base + h )}} - \frac{\partial {Y}_{k}}{\partial {X}_{p ( base )}}}{{X}_{q ( base + h )} - {X}_{q ( base )}} ; \qquad ( Equation - 2 )$$

where:
Xₚ and X_{q} are the pair of two input variables Xᵢ, p and q are positive integers, p≤n, q≤n;
X_{p(base+h)} is value of Xₚ at an alternative point differing from the base point, preferably in the vicinity of the base point;

$$\frac{\partial {Y}_{k}}{\partial {X}_{p ( base + h )}}$$

is first-order partial derivative of Yₖ with respect to Xₚ at the alternative point;
∂Yₖ/∂X_{p(base)} is first-order partial derivative of Yₖ with respect to Xₚ at the base point;

The step (A) can comprise (A-V) obtaining a square-term partial derivative, S_{r,k}, of Yₖ with respect to an input variable Xᵣ, at the base point, where:

$${S}_{r , k} = \frac{{\partial }^{2} {X}_{r}}{\partial {X}_{r}^{2}} = \frac{\frac{\partial {Y}_{k}}{\partial {X}_{r ( base + h )}} - \frac{\partial {Y}_{k}}{\partial {X}_{r ( base )}}}{2 \times ( {X}_{r ( base + h )} - {X}_{r ( base )} )} ; \qquad ( Equation - 3 )$$

where r is a positive integer, and 1≤Xᵣ≤n.

$$\frac{\partial {Y}_{k}}{\partial {X}_{r ( base + h )}}$$

is first-order partial derivative of Yₖ with respect to Xᵣ at the alternative point.

The step (A) can comprise (A-VI) calculating the value of Yₖ according to the following:
(A-VI.1) where n=1, and step (A-V) is carried out:

$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + Z 0 ; \qquad ( Equation - 4 a )$$

and
(A-VI.2) where n≥2, and
(A-VI.2a) where step (A-IV) is carried out and step (A-V) is optionally carried out:

$${Y}_{k} = {Y}_{k ( base )} + {\sum }_{i = 1}^{u} {A}_{i , k} \times ( {X}_{i} - {X}_{i ( base )} ) + {\sum }_{p = 1}^{v - 1} ( {\sum }_{q = p + 1}^{v} {C}_{p , q , k} \times ( {X}_{p} - {X}_{p ( base )} ) \times ( {X}_{q} - {X}_{q ( base )} ) ) + Z 0 ; \qquad ( Equation - 4 b \text{.1} )$$

or
(A-VI.2b) where step (A-IV) is optionally carried out and step (A-V) is carried out:

$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + Z 0 ; \qquad ( Equation - 4 b \text{.2} )$$

or
(A-VI.2c) where both step (A-IV) and step (A-V) are carried out:

$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + {\sum }_{p = 1}^{v - 1} ( {\sum }_{q = p + 1}^{v} {C}_{p , q , k} \times ( {X}_{p} - {X}_{p ( base )} ) \times ( {X}_{q} - {X}_{q ( base )} ) ) + Z 0 ; \qquad ( Equation - 4 b \text{.3} )$$

where u, v, and w are positive integers, u≤n, v≤n; and w≤n, and Z0 is a constant.

### BRIEF DESCRIPTION OF THE DRAWINGS

Various embodiments of this disclosure are illustrated by the following non-limiting drawings.

FIGS. 1a and 1b show and contrast one output variable, C8 aromatic hydrocarbon (“AC8”) yield (wt %) in the vertical axis, as a function of the research octane number (“RON”) of the reformate in the horizontal axis, obtained in Examples 1, 2, and 3 below, using a base point having a RON of 98 (FIG. 1a) or 103 (FIG. 1b), respectively.

FIGS. 1c and 1d show and contrast one output variable, C8 paraffinic hydrocarbon (“PA8”) yield (wt %) in the vertical axis, as a function of the research octane number (“RON”) of the reformate in the horizontal axis, obtained in Examples 1, 2, and 3 below, using a base point having a RON of 98 (FIG. 1c) and 103 (FIG. 1d), respectively.

FIG. 2a shows one output variable, C6 non-aromatic hydrocarbon (“C6 Non-A”) yield (wt %) in the vertical axis, as a function of the research octane number (“RON”) of the reformate in the horizontal axis, obtained in Examples 1 and 3 below, using a base point having a RON of 98 or a base point having a RON of 103.

FIG. 2b shows one output variable, C7 non-aromatic hydrocarbon (“C7 Non-A”) yield (wt %) in the vertical axis, as a function of the RON of the reformate in the horizontal axis, obtained in Examples 1 and 3 below, using a base point having a RON of 98 or a base point having a RON of 103.

FIG. 2c shows one output variable, C8 non-aromatic hydrocarbon (“C8 Non-A”) yield (wt %) in the vertical axis, as a function of the RON of the reformate in the horizontal axis, obtained in Examples 1 and 3 below, using a base point having a RON of 98 or a base point having a RON of 103.

FIG. 2d shows one output variable, C6 non-aromatic hydrocarbon (“C6 Non-A”) yield (wt %) in the vertical axis, as a function of the research octane number (“RON”) of the reformate in the horizontal axis, obtained in Examples 2 and 4 below, using a base point having a RON of 98 or a base point having a RON of 103.

FIG. 2e shows one output variable, C7 non-aromatic hydrocarbon (“C7 Non-A”) yield (wt %) in the vertical axis, as a function of the RON of the reformate in the horizontal axis, obtained in Examples 2 and 4 below, using a base point having a RON of 98 or a base point having a RON of 103.

FIG. 2f shows one output variable, C8 non-aromatic hydrocarbon (“C8 Non-A”) yield (wt %) in the vertical axis, as a function of the RON of the reformate in the horizontal axis, obtained in Examples 2 and 4 below, using a base point having a RON of 98 or a base point having a RON of 103.

FIGS. 3a and 3b show mass balances of the reformer as a function of RON, simulated in Examples 4 and 1 below, respectively.

### DETAILED DESCRIPTION

Various specific embodiments, versions and examples of the invention will now be described, including preferred embodiments and definitions that are adopted herein for purposes of understanding the claimed invention. While the following detailed description gives specific preferred embodiments, those skilled in the art will appreciate that these embodiments are exemplary only, and that the invention may be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

In this disclosure, a process is described as comprising at least one “step.” It should be understood that each step is an action or operation that may be carried out once or multiple times in the process, in a continuous or discontinuous fashion. Unless specified to the contrary or the context clearly indicates otherwise, multiple steps in a process may be conducted sequentially in the order as they are listed, with or without overlapping with one or more other steps, or in any other order, as the case may be. In addition, one or more or even all steps may be conducted simultaneously with regard to the same or different batch of material. For example, in a continuous process, while a first step in a process is being conducted with respect to a raw material just fed into the beginning of the process, a second step may be carried out simultaneously with respect to an intermediate material resulting from treating the raw materials fed into the process at an earlier time in the first step. Preferably, the steps are conducted in the order described.

Unless otherwise indicated, all numbers indicating quantities in this disclosure are to be understood as being modified by the term “about” in all instances. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for acquiring the measurement.

Certain embodiments and features are described herein using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated.

The indefinite article “a” or “an”, as used herein, means “at least one” unless specified to the contrary or the context clearly indicates otherwise. Thus, embodiments using “a reactor” or “a conversion zone” include embodiments where one, two or more reactors or conversion zones are used, unless specified to the contrary or the context clearly indicates that only one reactor or conversion zone is used.

The term “hydrocarbon” means (i) any compound consisting of hydrogen and carbon atoms or (ii) any mixture of two or more such compounds in (i). The term “Cn hydrocarbon,” where n is a positive integer, means (i) any hydrocarbon compound comprising carbon atom(s) in its molecule at the total number of n, or (ii) any mixture of two or more such hydrocarbon compounds in (i). Thus, a C2 hydrocarbon can be ethane, ethylene, acetylene, or mixtures of at least two of these compounds at any proportion. A “Cm to Cn hydrocarbon” or “Cm-Cn hydrocarbon,” where m and n are positive integers and m<n, means any of Cm, Cm+1, Cm+2, . . . , Cn-1, Cn hydrocarbons, or any mixtures of two or more thereof. Thus, a “C2 to C3 hydrocarbon” or “C2-C3 hydrocarbon” can be any of ethane, ethylene, acetylene, propane, propene, propyne, propadiene, cyclopropane, and any mixtures of two or more thereof at any proportion between and among the components. A “saturated C2-C3 hydrocarbon” can be ethane, propane, cyclopropane, or any mixture thereof of two or more thereof at any proportion. A “Cn+ hydrocarbon” means (i) any hydrocarbon compound comprising carbon atom(s) in its molecule at the total number of at least n, or (ii) any mixture of two or more such hydrocarbon compounds in (i). A “Cn− hydrocarbon” means (i) any hydrocarbon compound comprising carbon atoms in its molecule at the total number of at most n, or (ii) any mixture of two or more such hydrocarbon compounds in (i). A “Cm hydrocarbon stream” means a hydrocarbon stream consisting essentially of Cm hydrocarbon(s). A “Cm-Cn hydrocarbon stream” means a hydrocarbon stream consisting essentially of Cm-Cn hydrocarbon(s).

For the purposes of this disclosure, the nomenclature of elements is pursuant to the version of the Periodic Table of Elements (under the new notation) as provided in Hawley's Condensed Chemical Dictionary, 16^{th} Ed., John Wiley & Sons, Inc., (2016), Appendix V.

“Consisting essentially of” means comprising ≥60 mol %, preferably ≥75 mol %, preferably ≥80 mol %, preferably ≥90 mol %, preferably ≥95 mol %; preferably 98 mol %, of a given material or compound, in a stream or mixture, based on the total moles of molecules in the stream or mixture.

An exemplary industrial system in the processes of this disclose may comprise, and/or an exemplary industrial process in the processes in this disclosure may operate, one or more of the following: a feed pre-treatment sub-system (e.g., a crude pre-treatment sub-system; and the like); a reactor (e.g., a hydrotreater; a fluid catalytic convertor; a reformer; and the like); a pump; a compressor; an expander; a heat exchanger; a distillation column; a flash drum; a boiler; a furnace (e.g., a stream cracker furnace); an electric power supply (e.g., an electricity generator; a connection to an electricity supply grid; and the like); and a shaft power generator (e.g., an electric motor; a steam turbine; and the like).

An exemplary industrial system in the processes of this disclose may comprise, and/or an exemplary industrial process in the processes in this disclosure may operate, one or more of the following: a crude distillation column; a fluid catalytic converter; a hydroprocessing unit (e.g., a naphtha hydroprocessing unit); a reformer; an extraction unit; an adsorption separation unit; a petroleum refinery; a steam cracking furnace; a process gas compressor; a primary fractionation column; an acetylene converter; a refrigeration unit; a cryogenic separation unit; an olefins recovery section; an olefins production plant; and a chemical production plant.

As non-limiting examples of input variables Xᵢ in the processes of this disclosure, mention can be made of: a unit temperature (e.g., a flash drum temperature; a distillation column temperature; a reactor temperature; a boiler temperature; and the like); a unit pressure (e.g., a flash drum pressure; a distillation column pressure; a reactor pressure; a boiler pressure; and the like); a unit residence time (e.g., a reactor residence time such as a steam cracker residence time, and the like); a quantity of an overall feed mixture (e.g., a quantity of crude feed to a crude distillation column; a quantity of a hydrocarbon feed to a steam cracker; and the like); a quantity or a concentration of one or more major component of the feed mixture (e.g., an ethane concentration in an ethane feed into an ethane steam cracker; an ethylene concentration in a process gas stream fed into a process gas compressor in an olefins production plant; an propylene concentration in a process gas stream, and the like); a quantity or a concentration of one or more non-negligible contaminant in the feed mixture (e.g., an acetylene concentration in a process gas stream; an arsenic concentration in a process gas stream; and the like); a total quantity of catalyst in an reaction (e.g., a total quantity of catalyst used in a FCC; a total quantity of catalyst used in a hydrotreater, and the like); a quantity or concentration of one or more catalytically effective component in the catalyst (e.g., a quantity or concentration of a zeolite in a FCC catalyst; a quantity or concentration of a precious metal used in the hydrotreater; and the like); a unit energy efficiency (e.g., an energy efficiency of a steam turbine; an energy efficiency of a distillation column; and the like); a quantity or concentration of a product in a product-containing stream (e.g., an ethylene concentration in a stream fed into a C2 splitter in an olefins production plant; and the like); and a quantity or a concentration of one or more non-negligible contaminant in a product-containing stream (e.g., a CO concentration in the stream fed into the C2 splitter; and the like).

In the processes of this disclosure, the total number of input variables is n, where n is a positive integer. It is possible that only one input variable Xᵢ is involved, i.e., n=1. Preferably, n≥2, or n≥5, or n≥10, or n≥20, or n≥30, or n≥40, or n≥50, or n≥60, or n≥70, or n≥80, or n≥90, or n≥100. Preferably n≤1000, or n≤800, or n≤600, or n≤500, or n≤400, or n≤300, or n≤200. Where n≥2, the multiple input variables Xᵢ of the industrial process, system, or product in the processes of this disclosure may be all independent from each other. Alternatively, a portion, e.g., from 30%, 40%, 50%, 60%, to 70%, 80%, 90%, 95%, 98%, or even 99%, of the input variables are independent from each other. Preferably, a majority of the input variables are independent from each other.

The output variables Yₖ of the industrial system, the industrial process, or the industrial product can be approximately determined using the processes of this disclosure based on the values of input variables Xᵢ. In the processes of this disclosure, the total number of output variables is m, where m is a positive integer. It is possible that only one output variable Yₖ is involved, i.e., m=1. Preferably, m≥2, or m≥5, or m≥10, or m≥20, or m≥30, or m≥40, or m≥50, or m≥60, or m≥70, or m≥80, or m≥90, or m≥100. Preferably m≤1000, or m≤800, or m≤600, or m≤500, or m≤400, or m≤300, or m≤200.

As non-limiting examples of output variables Yₖ in the processes of this disclosure, mention can be made of: an overall quantity or yield of the industrial product (e.g., an overall quantity or yield of an ethylene product, or a propylene product, produced from an olefins production plant; and the like); an overall quantity or yield of a byproduct (e.g., an overall quantity or yield of a hydrogen stream produced from an olefins production plant; and the like); an overall quantity or yield of an intermediate product (e.g., an overall quantity or yield of a process gas stream separated from a steam cracker effluent in an olefins production plant, and the like); a quantity, a concentration, or a yield of one or more major component of the industrial product (e.g. a quantity, concentration, or yield of ethylene in an ethylene product produced from an olefins production plant; and the like); a quantity or a concentration of one or more non-negligible contaminant in the industrial product (e.g., a quantity, concentration, or yield of CO, CO₂, or acetylene in an ethylene product produced from an olefins production plant); a quantity of total energy consumed; a quantity of energy consumed by an individual equipment; a metallurgic limitation; a capacity limitation; a heat duty of an equipment; and a power consumption of an equipment.

In the industrial system, process, or product at issue in the processes of this disclosure, at least a part, preferably all, of the output variables Yₖ exhibit a non-linear behavior as a function of at least one, preferably a majority, preferably all, of the input variables Xᵢ. Simulating complex, non-linear systems and processes efficiently and effectively can be of great value in understanding and optimizing industrial systems, processes, and products. The processes of this disclosure meet this and other needs.

The non-linear reference tool useful in the processes of this disclosure can be a first-principles tool. First-principles tools are based on first-principles (i.e., mathematical relationships or logic that utilize accepted scientific theories or laws, such as those regarding chemical thermodynamics and/or kinetics, which theories or laws have been validated through repeated experimental tests). First-principles tools possess the capability to separately model many or all of the individual equipment units (e.g., a reactor, a column, and the like) in a large industrial system, the individual process steps (e.g., a reaction step, a separation step, and the like) in a complex multi-step industrial process, and intermediate or end products produced from such individual equipment unit or individual process steps. First-principles tools may include a library that provides thermodynamic information about how different molecules, components, or pseudo-components behave in such equipment units and process steps. Modeling results of individual equipment units and/or process steps obtainable using such first-principles tools can be then integrated to model a complex multi-unit industrial system, a complex multi-step industrial process, and various industrial products produced from such industrial system, process, and/or intermediate products. The integration may be performed optionally by using the first-principles tools as well. First-principles tools have been used for design, equipment rating, equipment performance evaluation, simulation, and optimization of industrial units, systems and processes. Non-limiting examples of commercially available first-principles tools useful in the processes of this disclosure are HYSIS®, Aspen Plus®, AspenTech RT-OPTO, which are products of Aspen Technologies Incorporated of Cambridge, Massachusetts, U.S.A.; PRO/II®, ROMeo®, which are available from AVEVA, Cambridge, England; and SPYRO®, which is a product of Technip-Coflexip SA of Paris, France. These powerful first-principles tools can be used in certain steps of the processes of this disclosure as described below.

The non-linear reference tool useful in the processes of this disclosure can be tools based on or derived from using artificial intelligence (“AI”) and/or machine learning (“ML”). Although not necessarily based on or derived from first principles such as thermodynamics and reaction kinetics, algorithms generated by AI/ML can be useful in simulating certain industrial systems, processes and products.

As useful as the non-linear reference tools are in industrial simulations, they tend to demand very high computing capability when simulating complex systems and processes with a large number of input variables and/or output variables. The processes of this disclosure uses such non-linear reference tools in limited steps to generate certain parameters as described below, with a relatively low computing capability requirement. The generated parameters are then used to construct model equation(s), which can then be used to efficiently calculate output variable values without the involvement of the non-linear reference tool.

In step (I) or (A-I) in the processes of this disclosure, a base point having a predetermined value of X_{i(base)} for each input variable Xᵢ is selected. The base point can be arbitrarily chosen within the operating window of Xᵢ. It is understood that in general, in a given industrial system, industrial process, or industrial product, for each input variable Xᵢ, an operating window exists limiting the variation of Xᵢ. In certain preferred embodiment, the X_{i(base)} may be chosen in the vicinity of values already known to be advantageous, based on, e.g., previous experiences of the industrial system, industrial process, or industrial product.

In step (II) or (A-II) in the processes of this disclosure, an output value of Y_{k(base)} at the base point is generated from the predetermined values of X_{i(base)} by using a non-linear reference tool, such as a non-linear reference tool described above. The non-linear reference tool can be based on, e.g., first principles such as thermodynamics and reaction kinetics, or artificial intelligence or machine learning. The non-linear reference tools are chosen such that the Y_{k(base)} values thus obtained are generally trust-worthy. In certain embodiments, the non-linear reference tool may be able to provide the Y_{k(base)} values directly. In other embodiments, step (II) or (A-II) can comprise:
(IIa) creating a non-linear reference model of the industrial system, the industrial process, and/or the industrial product by using the non-linear reference tool; and
(IIb) obtaining the output value of Y_{k(base)} from the predetermined values of X_{i(base)} using the non-liner reference model.

In a preferred embodiment, the non-linear reference model in step (IIa) is an LP model. In a preferred embodiment, step (IIb) comprises providing the X_{i(base)} values in a vector and generating the output values of Y_{k(base)} in a vector.

In step (III) or (A-III) in the processes of this disclosure, a first-order partial derivative, A_{i,k}, of Yₖ with respect to an Xᵢ at the base point, is obtained, where

$${A}_{i , k} = \frac{\partial {Y}_{k}}{\partial {X}_{i}} . \qquad ( Equation - 1 )$$

In certain embodiments, the A_{i,k} values may be directly obtainable from the non-linear reference tool. In other embodiments, the A_{i,k} values may be obtained by perturbing the base point. U.S. Pat. No. 7,257,451 B2 discloses how a comparative LP model is constructed from a non-linear reference model including a step of obtaining a first-order partial derivative at a base point, the relevant contents thereof are incorporated herein by reference in their entirety. The method disclosed and used for obtaining the first-order partial derivative in U.S. Pat. No. 7,257,451 B2, described in, e.g., from column 9, line 50 to column 10, line 26 therein, can be used and adapted for obtaining A_{i,k} in the processes of this disclosure in step (III) or (A-III). In other embodiments, the processes can comprise creating a non-linear reference model of the industrial system, the industrial process, and/or the industrial product using the non-linear reference tool; and obtaining the values of A_{i,k} using the non-linear reference model.

In optional step (IV) or (A-IV) in the process of this disclosure, where n≥2, i.e., where multiple input variables Xᵢ are involved, a cross-term partial derivative, C_{p,q,k}, of Yₖ with respect to a pair of two input variables Xᵢ at the base point can be obtained, where

$${C}_{p , q , k} = \frac{\partial \frac{\partial {Y}_{k}}{\partial {X}_{p}}}{\partial {X}_{q}} = \frac{\frac{\partial {Y}_{k}}{\partial {X}_{p ( base + h )}} - \frac{\partial {Y}_{k}}{\partial {X}_{p ( base )}}}{{X}_{q ( base + h )} - {X}_{q ( base )}} ; \qquad ( Equation - 2 )$$

where:
Xₚ and X_{q} are the pair of two input variables Xᵢ, p and q are positive integers, p≤n, q≤n;
X_{p(base+h)} is value of Xₚ at an alternative point differing from the base point, preferably in the vicinity of the base point;
X_{q(base+h)} is value of X_{q} at an alternative point differing from the base point, preferably in the vicinity of the base point;

$$\frac{\partial {Y}_{k}}{\partial {X}_{p ( base + h )}}$$

is first-order partial derivative of Yₖ with respect to Xₚ at a deviation point differing from the base point, preferably in the vicinity of the bae point; and
∂Yₖ/∂X_{p(base+h)} is first-order partial derivative of Yₖ with respect to Xₚ at the base point.

In certain preferred embodiments, the

$$\frac{\partial {Y}_{k}}{\partial {X}_{p ( base )}} and \frac{\partial {Y}_{k}}{\partial {X}_{p ( base + h )}}$$

values, which are first-order partial derivatives of Yₖ with respect to Xₚ at the base point and a deviation point differing from the base point, respectively, can be obtained in step (III)/(A-III) described above, or obtained in the same or similar manner as in step (III)/(A-III) described above. In certain embodiments, all input variables involved in step (III) or (A-III) are also involved in step (IV) or (A-IV). In other embodiments, overlapping but differing sets of input variables are involved in steps (III)/(A-III) and step (IV)/(A-IV). In other embodiments, totally differing sets of input variables may be involved in steps (III)/(A-III) and step (IV)/(A-IV).

In optional step (V)/(A-V) in the processes of this disclosure, a square-term partial derivative, S_{r,k}, of Yₖ with respect to an input variable Xᵣ, at the base point is obtained, where:

$${S}_{r , k} = \frac{{\partial }^{2} {X}_{r}}{\partial {X}_{r}^{2}} = \frac{\frac{\partial {Y}_{k}}{\partial {x}_{r ( base + h )}} - \frac{\partial {Y}_{k}}{\partial {x}_{r ( base )}}}{2 \times ( {X}_{r ( base + h )} - {X}_{r ( base )} )} ; \qquad ( Equation - 3 )$$

where:
r is a positive integer, and 1≤r≤n;
X_{r(base+h)} is value of Xₚ at an alternative point differing from the base point, preferably in the vicinity of the base point; and

$$\frac{\partial {Y}_{k}}{\partial {X}_{r ( base + h )}}$$

is first-order partial derivative of Yₖ with respect to Xᵣ at the alternative point.

In certain preferred embodiments, the

$$\frac{\partial {Y}_{k}}{\partial {X}_{r ( base )}} and \frac{\partial {Y}_{k}}{\partial {X}_{r ( base + h )}}$$

values which are first-order partial derivatives of Yₖ with respect to Xᵣ at the base point and a deviation point differing from the base point, respectively, can be obtained in step (III)/(A-III) described above, or obtained in the same or similar manner as in step (III)/(A-III) described above. In certain embodiments, all input variables involved in step (III) or (A-III) are also involved in step (V)/(A-V). In other embodiments, overlapping but differing sets of input variables are involved in steps (III)/(A-III) and step (V)/(A-V). In other embodiments, totally differing sets of input variables may be involved in steps (III)/(A-III) and step (V)/(A-V). In certain embodiments, all input variables involved in step (IV) or (A-IV) are also involved in step (V)/(A-V). In other embodiments, overlapping but differing sets of input variables are involved in steps (IV)/(A-IV) and step (V)/(A-V). In other embodiments, totally differing sets of input variables may be involved in steps (IV)/(A-IV) and step (V)/(A-V).

In step (VI)/(A-VI) in the processes of this disclosure, Yₖ values can be calculated based on the above obtained Y_{k(base)}, S_{r,k}, and C_{p,q,k} values where applicable, using an LP model. Thus, where only one input variable Xᵢ is involved in the processes, step (IV) is not carried out and step (V) is carried out, Yₖ is calculated pursuant to Equation-4a below:

$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + Z 0. \qquad ( Equation - 4 a )$$

Where multiple variable Xᵢ are involved in the processes, step (IV)/(A-IV) is carried out, and step (V)/(A-V) is optionally carried out (preferably step (V)/(A-V) is not carried out), in certain embodiments Yₖ can be calculated pursuant to Equation-4b.1 below:

$${Y}_{k} = {Y}_{k ( base )} + {\sum }_{i = 1}^{u} {A}_{i , k} \times ( {X}_{i} - {X}_{i ( base )} ) + {\sum }_{p = 1}^{v - 1} ( {\sum }_{q = p + 1}^{v} {C}_{p , q , k} \times ( {X}_{p} - {X}_{p ( base )} ) \times ( {X}_{q} - {X}_{q ( base )} ) ) + Z 0. \qquad ( Equation - 4 b \text{.1} )$$

Preferably, in embodiments using Equation-4b.1, the square-term terms' impacts (or “square-term shifts”) represented by

$${\sum }_{r = 1}^{w} {S}_{r , k} \times {( {X}_{r} - {X}_{r ( base )} )}^{2}$$

are predetermined to be negligible.

Where multiple variable Xᵢ are involved in the processes, step (IV)/(A-IV) is optionally carried out (preferably step (IV)/(A-IV) is not carried out), and step (V)/(A-V) is carried out, in certain embodiments Yₖ can be calculated pursuant to Equation-4b.2 below:

$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + Z 0. \qquad ( Equation - 4 b \text{.2} )$$

Preferably, in embodiments using Equation-4b.2, the cross-terms' impacts (or “cross-term shifts”) represented by

$${\sum }_{p = 1}^{v - 1} ( {\sum }_{q = p + 1}^{v} {c}_{p , q , k} \times ( {X}_{p} - {X}_{p ( base )} ) \times ( {X}_{q} - {X}_{q ( base )} ) ) + Z 0$$

are predetermined to be negligible.

Where multiple variable Xᵢ are involved in the processes, and both steps (IV)/(A-IV) and (V)/(A-V) are carried out, in certain embodiments Yₖ can be calculated pursuant to Equation-4b.3 below,

$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + {\sum }_{p = 1}^{v - 1} ( {\sum }_{q = p + 1}^{v} {C}_{p , q , k} \times ( {X}_{p} - {X}_{p ( base )} ) \times ( {X}_{q} - {X}_{q ( base )} ) ) + Z 0. \qquad ( Equation - 4 b \text{.3} )$$

Where a single output variable Y is involved, Equation-4a can be simplified to Equation-5a below:

$$Y = {Y}_{( base )} + {\sum }_{i = 1}^{u} {A}_{i} \times ( {X}_{i} - {X}_{i ( base )} ) + {\sum }_{r = 1}^{w} {S}_{r} \times {( {X}_{r} - {X}_{r ( base )} )}^{2} + Z 0. \qquad ( Equation - 5 a )$$

Where a single output variable Y is involved, Equations-4b.1, 4b.2, and 4b.3 can be simplified to Equations-5b.1, 5b.2, and 5b.3 below, respectively:

$$Y = {Y}_{( base )} + {\sum }_{i = 1}^{u} {A}_{i} \times ( {X}_{i} - {X}_{i ( base )} ) + {\sum }_{p = 1}^{v - 1} ( {\sum }_{q = p + 1}^{v} {C}_{p , q} \times ( {X}_{p} - {X}_{p ( base )} ) \times ( {X}_{q} - {X}_{q ( base )} ) ) + Z 0 ; \qquad ( Equation - 5 b \text{.1} )$$

$$Y = {Y}_{( base )} + {\sum }_{i = 1}^{u} {A}_{i} \times ( {X}_{i} - {X}_{i ( base )} ) + {\sum }_{r = 1}^{w} {S}_{r} \times {( {X}_{r} - {X}_{r ( base )} )}^{2} + Z 0 ; \qquad ( Equation - 5 b \text{.2} )$$

$$and$$

$$Y = {Y}_{( base )} + {\sum }_{i = 1}^{u} {A}_{i} \times ( {X}_{i} - {X}_{i ( base )} ) + {\sum }_{r = 1}^{w} {S}_{r} \times {( {X}_{r} - {X}_{r ( base )} )}^{2} + {\sum }_{p = 1}^{v - 1} ( {\sum }_{q = p + 1}^{v} {C}_{p , q} \times ( {X}_{p} - {X}_{p ( base )} ) \times ( {X}_{q} - {X}_{q ( base )} ) ) + Z 0 . \qquad ( Equation - 5 b \text{.3} )$$

It should be appreciated that in the above Equation-4a, Equation-5a, Equations-4b.1, 4.b.2, 4b.3, and Equations-5b.1, 5b.2, 5b.3, u, v, and w are positive integers, u≤n, v≤n; and w≤n. In certain embodiments u=v=w. In certain other embodiments u=v=w=n.

In Equation-4a, Equation-5a, Equations-4b1.4b.2, 4b.3, and Equations-5b.1, 5b.2, 5b.3, Z0 is an arbitrary constant. In certain embodiments, preferably Z0 is zero.

In step (VI)/(A-VI) in the processes of this disclosure, matrix multiplication can be advantageously utilized to achieve a high-efficiency calculation involving potentially large number of variables. To that end, one or more of the following can be carried out:
(i) the input variables Xᵢ(1≤i≤u), Xₚ (1≤p≤v−1), X_{q}(2≤q≤v), or Xᵣ (1≤r≤w) values are provided in a vector;
(ii) the A_{i,k} values are provided in a matrix;
(iii) the C_{p,q,k} values are provided in a matrix;
(iv) the S_{r,k} values are provided in a matrix;
(v) at least one of the Xᵢ−Xᵢ(base), Xₚ−Xₚ(base), X_{q}−X_{q(base)} or Xᵣ−X_{r(base)} values is provided in a vector;
(vi) the (Xᵣ−X_{r(base)})² values are provided in a vector; and
(vii) step (VI) is carried out using matrix multiplication to calculate output variables Yₖ values and the process further comprises providing the Yₖ values in a vector.

In advantageous embodiments where u=v=w=n, step (VI)/(A-VI) can be performed in conformance with at least one of the following to take advantage of high-efficiency matrix/vector multiplication operations:
(i) the n input variables Xᵢ are provided in a vector having n dimensions;
(ii) the A_{i,k} values are provided in a matrix having n×m dimensions;
(iii) the C_{p,q,k} values are provided in a matrix having [n×(n−1)]×m dimensions;
(iv) the S_{r,k} values are provided in a matrix having n×m dimensions;
(v) at least one of the Xᵢ−Xᵢ(base), Xₚ−X_{p(base)}, X_{q}−X_{q(base)} or Xᵣ−X_{r(base)} values are provided in a vector having n dimensions;
(vi) the (Xᵣ−X_{r(base)})² values are provided in a vector having n dimensions; and (vii) step (VI) is carried out using matrix multiplication to calculate output variables Yₖ values and the process further comprises providing the Yₖ values in a vector having m dimensions.

In the processes according to the second aspect of this disclosure, a first set of values of one or more of Yₖ calculated from a first set of input variables Xᵢ using the above described process are then used in step (B) for optimizing the industrial system, the industrial process, and/or the industrial product. In certain embodiments, commercially available optimization software based on well-known algorithms, such as linear programming algorithms, may be used in step (B).

In certain embodiments, step (B) can comprise:
(B-1) repeating step (A-VI) at one or more alternative set of Xᵢ differing from the first set of Xᵢ, to determine one or more corresponding alternative set of value of the one or more of Yₖ;
(B-2) comparing the first and alternative sets of values of the one or more of Yₖ; and
(B-3) selecting an optimized set of Xᵢ for the industrial system, the industrial process, and/or the industrial product based at least partly on the comparing result in step (B-2).

Step (B-1) may be performed at least 2, 4, 5, 6, 8, 10, 20, 40, 50, 60, 80, 100, 200, 400, 500, 600, 800, 1000, 1500, 2000, 2500, 3000, 3500, 4000, 4500, 5000, 6000, 7000, 8000, 9000, 10000, 50000, or even 100000 times. Such large number of operations can be efficiently and effectively carried out using a computer by taking advantage of the matrix/vector operations as described above. From the large number of calculations, with the aid of tools such as computers, one can choose the optimized set of Xᵢ for the industrial system, the industrial process, or the industrial product. Advantageously, one can utilize commercially available optimization software in this step.

Alternatively, step (B) can comprise the following:
(B-i) repeating step (A-VI) at one or more alternative set of Xᵢ differing from the first set of Xᵢ, to determine one or more corresponding alternative set of value of the one or more of Yₖ;
(B-ii) calculating a first cost and/or profit of the industrial system, the industrial process, and industrial product based on the first set of value of one or more of Yₖ;
(B-iii) calculating an alternative cost and/or an alternative profit of the industrial system, the industrial process, and industrial product based on each of the one or more alternative set of value of the one or more of Yₖ;
(B-iv) comparing the first and alternative cost and/or the first and alternative profit; and
(B-v) selecting an optimized set of Xᵢ for the industrial system, the industrial process, and/or the industrial product based at least partly on the comparing result in step (B-iv).

Step (B-i) may be performed at least 2, 4, 5, 6, 8, 10, 20, 40, 50, 60, 80, 100, 200, 400, 500, 600, 800, 1000, 1500, 2000, 2500, 3000, 3500, 4000, 4500, 5000, 6000, 7000, 8000, 9000, 10000, 50000, or even 100000 times. Such large number of operations can be efficiently and effectively carried out using a computer by taking advantage of the matrix/vector operations as described above. From the large number of calculations, with the aid of tools such as computers, one can choose the optimized set of Xᵢ for the industrial system, the industrial process, or the industrial product, achieving the desirable costs and/or profits. Advantageously, one can utilize certain optimization software in this step. In certain embodiments, the costs and/or profits may exhibit a linear relationship with one or more of the Yₖ values, which can be used to calculate the costs and/or profits based on the Yₖ values.

Non-limiting examples of commercially available optimization software useful for step (B) include: Aspen PIMS-AO™ available from Aspen Technology Inc.; AVEVA Unified available from Aveva Group plc; Petrel E&P available from Schlumberger Limited; AIMMS available from AIMMS B.V.; CPLEX available from International Business Machine Corporation; MATLAB available from MathWorks; and Mathematica available from Wolfram Research.

The comparative LP model disclosed in U.S. Pat. No. 7,257,451 can be represented by Equation-6:

$${Y}_{k} = {Y}_{k ( base )} + {\sum }_{i = 1}^{u} {A}_{i , k} \times ( {X}_{i} - {X}_{i ( base )} ) . \qquad ( Equation - 6 )$$

The present inventors have found that, by taking into consideration of the value of

$${\sum }_{r = 1}^{w} {S}_{r , k} \times {( {X}_{r} - {X}_{r ( base )} )}^{2}$$

where a single input variable is concerned (i.e., n=1), or taking into consideration of one or both of

$${\sum }_{r = 1}^{w} {S}_{r , k} \times {( {X}_{r} - {X}_{r ( base )} )}^{2}$$

$$and$$

$${\sum }_{p = 1}^{v - 1} ( {\sum }_{q = p + 1}^{v} {C}_{p , q , k} \times ( {X}_{p} - {X}_{p ( base )} ) \times ( {X}_{q} - {X}_{q ( base )} ) ) ,$$

where multiple input variables are involved, surprisingly more accurate simulation of Yₖ values can be achieved by using the processes of this disclosure compared to exiting simulation processes such as those using models represented by Equation-6. This is further illustrated by comparing Examples 1, 2 and 3 below.

In the prior art, linear programming models similar to Equation-4b.3, having the following Equation-7, have been constructed and used:

$${Y}_{k} = {Y}_{k ( base )} + {\sum }_{i = 1}^{u} {R}_{i , k} \times ( {X}_{i} - {X}_{i ( base )} ) + {\sum }_{r = 1}^{w} {R}_{r , k} \times {( {X}_{r} - {X}_{r ( base )} )}^{2} + {\sum }_{p = 1}^{v - 1} ( {\sum }_{q = p + 1}^{v} {R}_{p , q , k} \times ( {X}_{p} - {X}_{p ( base )} ) \times ( {X}_{q} - {X}_{q ( base )} ) ) , \qquad ( Equation - 7 )$$

where the coefficients R_{i,k}, R_{r,k}, and R_{p,q,k} are generated by data regression, in contrast to the A_{i,k}, S_{r,k}, and C_{p,q,k} in the processes of this disclosure, which are partial derivatives generated by fundamental, mathematical partial derivation as described above.

Regression equations such as Equation-7, while useful to a certain extent and used widely in in simulating industrial processes, suffer from several major disadvantages. First, regression equations do not reflect true process fundamentals. Therefore, equation coefficients are not transparent from an engineering point of view. Regression rangeability is limited to the range of data used for regression (i.e., the design of experiments, “DoE”). Therefore, regression is not capable of extrapolative predictions, which is needed for optimization models and is needed any time actual operations extend beyond the original DoE. Regression coefficients are statistically estimated and, hence, are not understandable. Regression equations may not preserve mass balance. This leads to artificial creation or destruction of mass, which will give inaccurate model predictions. The processes of this disclosure, utilizing partially derived equations above, do not have these disadvantages. This is further illustrated by comparing Examples 1, 2, and 4 below.

The enhanced calculations of the output values using the models of the processes of this disclosure enable improved optimization of industrial systems, industrial processes, or industrial products, including but not limited to those in the petrochemical industry.

The processes of this disclosure are further illustrated by the following non-limiting examples.

### EXAMPLES

### Example 1 (Inventive)

An LP model for a reformer in a petrochemical facility was constructed using the processes of this disclosure. First, a rigorous non-linear, first-principles-based reference model of the reformer was constructed using the AVEVA ROMeo® reference tool, which was then used for constructing the LP simulation model pursuant to this disclosure as described below. This first-principles reference model included reformer reactor beds, furnaces for reactor preheat, towers/drums for product separation, and recycle H₂ compressor, and was also used in Example 2 below. One having ordinary skill in the art understands how to construct the first-principles based reference models using AVERA ROMeo®. While the number of input and output variables can vary considerably for various units or operating facilities, processes, and products, this example has been limited to 27 input variables and 10 output variables.

Tables 1A, 1B, and 1C below show all raw data extracted from the non-linear, first-principles-based reference model to implement this invention.

TABLE 1A.1

| | | | 104 | 106 | 108 | 110 | 112 | 114 |
|---|---|---|---|---|---|---|---|---|
| | | 102 | Nick | Base | Alternate | Test | Absolute | Relative |
| | | Variable Name | Name | Case | Case | Case | Delta | Delta |
| 116 | Input | C5 Paraffins, tonm/hr | PA5 | 0.081 | 0.081 | 2.122 | 2.041 | 2532% |
| | Variables | C6 Paraffins, tonm/hr | PA6 | 25.260 | 25.260 | 13.675 | −11.584 | −46% |
| | | C7 Paraffins, tonm/hr | PA7 | 22.990 | 22.990 | 26.541 | 3.551 | 15% |
| | | C8 Paraffins, tonm/hr | PA8 | 23.569 | 23.569 | 24.019 | 0.450 | 2% |
| | | C9 Paraffins, tonm/hr | PA9 | 38.704 | 38.704 | 21.444 | −17.261 | −45% |
| | | C10 Paraffins, tonm/hr | P10 | 22.095 | 22.095 | 14.080 | −8.015 | −36% |
| | | C11 Paraffins, tonm/hr | P11 | 1.508 | 1.508 | 5.491 | 3.983 | 264% |
| | | Cyclopentane, tonm/hr | N55 | 0.239 | 0.239 | 0.350 | 0.111 | 46% |
| | | C6 Cyclopentanes, tonm/hr | N65 | 6.461 | 6.461 | 3.604 | −2.857 | −44% |
| | | C6 Cyclohexanes, tonm/hr | N66 | 6.362 | 6.362 | 5.814 | −0.549 | −9% |
| | | C7 Cyclopentanes, tonm/hr | N75 | 8.593 | 8.593 | 9.810 | 1.217 | 14% |
| | | C7 Cyclohexanes, tonm/hr | N76 | 9.337 | 9.337 | 9.954 | 0.617 | 7% |
| | | C8 Cyclopentanes, tonm/hr | N85 | 8.071 | 8.071 | 8.411 | 0.340 | 4% |
| | | C8 Cyclohexanes, tonm/hr | N86 | 13.549 | 13.549 | 11.022 | −2.527 | −19% |
| | | C9 Cyclopentanes, tonm/hr | N95 | 11.167 | 11.167 | 7.311 | −3.856 | −35% |
| | | C9 Cyclohexanes, tonm/hr | N96 | 19.851 | 19.851 | 9.554 | −10.297 | −52% |
| | | C10 Naphthenes, tonm/hr | N10 | 7.954 | 7.954 | 8.703 | 0.749 | 9% |
| | | C11 Naphthenes, tonm/hr | N11 | 0.419 | 0.419 | 1.535 | 1.116 | 267% |
| | | C6 Aromatics, tonm/hr | AC6 | 2.639 | 2.639 | 1.713 | −0.926 | −35% |
| | | C7 Aromatics, tonm/hr | AC7 | 4.267 | 4.267 | 5.745 | 1.478 | 35% |
| | | C8 Aromatics, tonm/hr | AC8 | 14.534 | 14.534 | 8.841 | −5.694 | −39% |
| | | C9 Aromatics, tonm/hr | AC9 | 11.908 | 11.908 | 7.202 | −4.706 | −40% |
| | | C10 Aromatics, tonm/hr | AC0 | 0.390 | 0.390 | 3.237 | 2.847 | 730% |
| | | C11+ Aromatics, tonm/hr | A11 | 0.052 | 0.052 | 0.235 | 0.183 | 351% |
| | | Severity, C6+ Reformate RON | sev | 98.000 | 103.000 | 101.907 | 3.907 | 4% |
| | | Operating Pressure, psig | PRS | 103.939 | 103.939 | 111.254 | 7.315 | 7% |
| | | H₂ Recycle Ratio | HRR | 1.780 | 1.780 | 1.498 | −0.282 | −16% |

TABLE 1A.2

| | | | | | | |
|---|---|---|---|---|---|---|
| | 104 | 106 | 108 | 11 | 112 | 114 |
| 102 | Nick | Base | Alternate | Test | Absolute | Relative |
| Variable Name | Name | Case | Case | Case | Delta | Delta |

| | | | | | |
|---|---|---|---|---|---|
| 118 | Output | Hydrogen, tonm/hr | 7.688 | 8.718 | 6.792 |
| | Variables | Fuel Gas, tonm/hr | 3.190 | 4.866 | 3.810 |
| | | Propane, tonm/hr | 4.376 | 6.529 | 5.049 |
| | | Butanes, tonm/hr | 4.855 | 7.797 | 6.077 |
| | | Pentanes, tonm/hr | 7.757 | 10.468 | 10.356 |
| | | C6+ reformate, tonm/hr | 232.135 | 221.622 | 178.326 |
| | | Total Fired Duty, MW | 150.512 | 168.133 | 130.020 |
| | | Max inlet temperature, ° C. | 427.312 | 449.348 | 439.078 |
| | | C6+ Reformate | 0.813 | 0.833 | 0.829 |
| | | Specific Gravity | | | |
| | | Aromatics (vol %) | 65.522 | 76.996 | 74.324 |

TABLE 1B.1

| | | 120 | | | | | | |
|---|---|---|---|---|---|---|---|---|
| | | PA5 | PA6 | PA7 | PA8 | PA9 | P10 | P11 |
| 122 | Hydrogen, tonm/hr | 0.007991 | 0.021134 | 0.028422 | 0.040687 | 0.035764 | 0.032748 | 0.030259 |
| | Fuel Gas, tonm/hr | 0.013319 | 0.037309 | 0.038362 | 0.032263 | 0.026578 | 0.027631 | 0.050892 |
| | Propane, tonm/hr | 0.006142 | 0.041195 | 0.052254 | 0.052465 | 0.041641 | 0.035353 | 0.058183 |
| | Butanes, tonm/hr | 0.041847 | 0.057621 | 0.069465 | 0.069795 | 0.041592 | 0.033159 | 0.055475 |
| | Pentanes, tonm/hr | 0.542918 | 0.05523 | 0.063173 | 0.068015 | 0.039093 | 0.025826 | 0.054965 |
| | C6+ reformate, tonm/hr | 0.387782 | 0.78751 | 0.748324 | 0.736774 | 0.815332 | 0.845284 | 0.750226 |
| | Total Fired Duty, MW | 0.289795 | 0.510247 | 0.602837 | 0.742855 | 0.650688 | 0.603384 | 0.599661 |
| | Max inlet temperature, ° C. | −0.017959 | 0.26267 | 0.30332 | 0.328181 | 0.18358 | 0.124637 | 0.249497 |
| | C6+ Reformate | −0.000278 | −0.000421 | −0.00017 | 0.000051 | 0.000019 | 0.000028 | 0.000108 |
| | Specific Gravity | | | | | | | |
| | Aromatics (vol %) | −0.079411 | −0.12577 | −0.0584 | 0.037966 | 0.00768 | 0.000867 | 0.020832 |

TABLE 1B.2

| | | N55 | N65 | N66 | N75 | N76 | N85 | N86 |
|---|---|---|---|---|---|---|---|---|
| 122 | Hydrogen, tonm/hr | 0.02111 | 0.047126 | 0.068124 | 0.044677 | 0.050125 | 0.042836 | 0.043705 |
| | Fuel Gas, tonm/hr | 0.021478 | 0.002572 | −0.00282 | −0.00573 | −0.01294 | −0.00852 | −0.01057 |
| | Propane, tonm/hr | 0.029363 | 0.004289 | −0.00109 | −0.00698 | −0.01529 | −0.00989 | −0.01243 |
| | Butanes, tonm/hr | 0.0395 | 0.006476 | −0.00047 | −0.00815 | −0.01896 | −0.01209 | −0.01541 |
| | Pentanes, tonm/hr | 0.171575 | −0.00229 | −0.01118 | −0.02227 | −0.03462 | −0.02882 | −0.03281 |
| | C6+ reformate, tonm/hr | 0.716973 | 0.941826 | 0.947421 | 0.998451 | 1.031679 | 1.016478 | 1.027508 |
| | Total Fired Duty, MW | 0.517207 | 0.855397 | 1.422457 | 0.838219 | 1.085559 | 0.789989 | 0.929733 |
| | Max inlet temperature, ° C. | 0.298159 | 0.298524 | 0.229005 | 0.094353 | 0.002571 | 0.021939 | −0.00103 |
| | C6+ Reformate | −0.000071 | 0.000031 | 0.000188 | 0.000005 | 0.000033 | 0.000058 | 0.000059 |
| | Specific Gravity | | | | | | | |
| | Aromatics (vol %) | −0.07096 | −0.01158 | 0.085122 | 0.004021 | 0.014549 | 0.030305 | 0.030358 |

TABLE 1B.3

| | | N95 | N96 | N10 | N11 | AC6 | AC7 | AC8 |
|---|---|---|---|---|---|---|---|---|
| 126 | Hydrogen, tonm/hr | 0.036885 | 0.036892 | 0.038042 | 0.035986 | −0.00237 | −0.01136 | −0.00984 |
| | Fuel Gas, tonm/hr | −0.01136 | −0.01198 | −0.0113 | −0.00996 | −0.00636 | −0.01684 | −0.01457 |
| | Propane, tonm/hr | −0.013294 | −0.01303 | −0.01223 | −0.01216 | −0.00847 | −0.02276 | −0.01972 |
| | Butanes, tonm/hr | −0.018918 | −0.01936 | −0.019 | −0.01536 | −0.00991 | −0.02853 | −0.02478 |
| | Pentanes, tonm/hr | −0.037371 | −0.03768 | −0.03865 | −0.03406 | −0.0185 | −0.04276 | −0.04141 |
| | C6+ reformate, tonm/hr | 1.044058 | 1.045153 | 1.043138 | 1.03555 | 1.045616 | 1.122249 | 1.110325 |
| | Total Fired Duty, MW | 0.698743 | 0.797347 | 0.783352 | 0.725867 | 0.12003 | −0.02319 | 0.002142 |
| | Max inlet temperature, ° C. | −0.077174 | −0.07008 | −0.0923 | −0.09953 | −0.10921 | −0.29771 | −0.27438 |
| | C6+ Reformate | 0.00006 | 0.000078 | 0.0002 | 0.000171 | 0.000202 | 0.000029 | 0.000059 |
| | Specific Gravity | | | | | | | |
| | Aromatics (vol %) | 0.018615 | 0.018316 | −0.00427 | −0.00389 | 0.092421 | 0.012759 | 0.028967 |

TABLE 1B.4

| | | | | | 124 | | |
|---|---|---|---|---|---|---|---|
| | | AC9 | AC10 | A11 | sev | PRS | HRR |
| 126 | Hydrogen, tonm/hr | −0.01115 | −0.01259 | −0.01052 | 0.20734 | −0.01314 | −0.0446 |
| | Fuel Gas, tonm/hr | −0.01468 | −0.01538 | −0.01129 | 0.251575 | 0.038254 | 0.310578 |
| | Propane, tonm/hr | −0.01775 | −0.01916 | −0.01536 | 0.341601 | 0.042055 | 0.312222 |
| | Butanes, tonm/hr | −0.02681 | −0.02886 | −0.0181 | 0.439451 | 0.04911 | 0.458067 |
| | Pentanes, tonm/hr | −0.04402 | −0.04699 | −0.03684 | 0.4716 | 0.060646 | 0.441296 |
| | C6+ Reformate, tonm/hr | 1.114406 | 1.122979 | 1.092105 | −1.71157 | −0.17693 | −1.47756 |
| | Total Fired Duty, MW | −0.0214 | −0.04622 | −0.02354 | 3.36218 | −0.12254 | 1.687211 |
| | Max inlet temperature, ° C. | −0.30071 | −0.34179 | −0.32235 | 4.115152 | 0.127477 | 4.099751 |
| | C6+ Reformate | 0.00005 | 0.000049 | 0.000083 | 0.003262 | −1.9E−05 | 0.000644 |
| | Specific Gravity | | | | | | |
| | Aromatics (vol %) | 0.018068 | −0.00146 | −0.00235 | 2.030954 | 0.001602 | 0.340162 |

TABLE 1C.1

| | | 130 | | | | | | |
|---|---|---|---|---|---|---|---|---|
| | | PA5 | PA6 | PA7 | PA8 | PA9 | P10 | P11 |
| 132 | Hydrogen, tonm/hr | 0.009685 | 0.022777 | 0.032280 | 0.044290 | 0.039962 | 0.037095 | 0.032846 |
| | Fuel Gas, tonm/hr | 0.027631 | 0.077971 | 0.057137 | 0.032988 | 0.028326 | 0.028900 | 0.057277 |
| | Propane, tonm/hr | 0.016616 | 0.082761 | 0.080086 | 0.055188 | 0.045074 | 0.037857 | 0.063572 |
| | Butanes, tonm/hr | 0.074616 | 0.124515 | 0.111473 | 0.075791 | 0.045172 | 0.034608 | 0.059131 |
| | Pentanes, tonm/hr | 0.544467 | 0.087277 | 0.087024 | 0.061444 | 0.033102 | 0.019805 | 0.049229 |
| | C6+ reformate, tonm/hr | 0.326986 | 0.604698 | 0.632001 | 0.730299 | 0.808364 | 0.841734 | 0.737945 |
| | Total Fired Duty, MW | 0.357016 | 0.608229 | 0.686469 | 0.802284 | 0.724072 | 0.675877 | 0.635631 |
| | Max inlet temperature, ° C. | 0.020740 | 0.326459 | 0.250967 | 0.239323 | 0.136812 | 0.083372 | 0.154806 |
| | C6+ Reformate | −0.000244 | −0.000293 | −0.000081 | 0.000037 | −0.000008 | −0.000005 | 0.000074 |
| | Specific Gravity | | | | | | | |
| | Aromatics (vol %) | −0.069828 | −0.090003 | −0.033725 | 0.026628 | −0.000051 | −0.010299 | 0.008091 |

TABLE 1C.2

| | | N55 | N65 | N66 | N75 | N76 | N85 | N86 |
|---|---|---|---|---|---|---|---|---|
| 132 | Hydrogen, tonm/hr | 0.022398 | 0.056123 | 0.070707 | 0.046692 | 0.053011 | 0.047854 | 0.048735 |
| | Fuel Gas, tonm/hr | 0.048214 | 0.012408 | −0.000075 | −0.005338 | −0.017817 | −0.007224 | −0.009226 |
| | Propane, tonm/hr | 0.057081 | 0.016235 | 0.004358 | −0.002595 | −0.017600 | −0.005329 | −0.007744 |
| | Butanes, tonm/hr | 0.086171 | 0.024355 | 0.006401 | −0.004260 | −0.025332 | −0.007952 | −0.011309 |
| | Pentanes, tonm/hr | 0.221613 | 0.003455 | −0.012561 | −0.020041 | −0.040288 | −0.027584 | −0.031250 |
| | C6+ Reformate, tonm/hr | 0.564523 | 0.887424 | 0.931169 | 0.985541 | 1.048025 | 1.000235 | 1.010794 |
| | Total Fired Duty, MW | 0.609580 | 1.030460 | 1.472715 | 0.881287 | 1.119913 | 0.876124 | 1.008737 |
| | Max inlet temperature, ° C. | 0.403058 | 0.365996 | 0.243979 | 0.066724 | 0.000860 | 0.061382 | 0.052192 |
| | C6+ Reformate | 0.000027 | 0.000056 | 0.000153 | −0.000063 | −0.000061 | 0.000028 | 0.000028 |
| | Specific Gravity | | | | | | | |
| | Aromatics (vol %) | −0.036275 | 0.021782 | 0.067557 | −0.024833 | −0.022911 | 0.024629 | 0.024739 |

TABLE 1C.3

| | | N95 | N96 | N10 | N11 | AC6 | AC7 | AC8 |
|---|---|---|---|---|---|---|---|---|
| 136 | Hydrogen, tonm/hr | 0.041949 | 0.041935 | 0.043304 | 0.042628 | 0.000898 | −0.007571 | −0.003923 |
| | Fuel Gas, tonm/hr | −0.010580 | −0.011357 | −0.011159 | −0.009298 | −0.004351 | −0.022873 | −0.013616 |
| | Propane, tonm/hr | −0.009703 | −0.009388 | −0.009836 | −0.009120 | −0.005602 | −0.027901 | −0.016725 |
| | Butanes, tonm/hr | −0.016954 | −0.017408 | −0.019705 | −0.015558 | −0.006441 | −0.038815 | −0.023027 |
| | Pentanes, tonm/hr | −0.036863 | −0.037193 | −0.039925 | −0.035020 | −0.016472 | −0.046005 | −0.036846 |
| | C6+ Reformate, tonm/hr | 1.032153 | 1.033412 | 1.037321 | 1.026367 | 1.031969 | 1.143165 | 1.094137 |
| | Total Fired Duty, MW | 0.782441 | 0.875922 | 0.862555 | 0.820512 | 0.183284 | 0.025768 | 0.093971 |
| | Max inlet temperature, ° C. | −0.032732 | −0.019083 | −0.045373 | −0.043642 | −0.078258 | −0.282865 | −0.196629 |
| | C6+ Reformate | 0.000022 | 0.000040 | 0.000174 | 0.000157 | 0.000163 | −0.000070 | 0.000027 |
| | Specific Gravity | | | | | | | |
| | Aromatics (vol %) | 0.009567 | 0.009436 | −0.016771 | −0.016871 | 0.072990 | −0.026098 | 0.024526 |

TABLE 1C.4

| | | | | | 134 | | |
|---|---|---|---|---|---|---|---|
| | | AC9 | AC10 | A11 | sev | PRS | HRR |
| 136 | Hydrogen, tonm/hr | −0.005324 | −0.006310 | −0.002576 | 0.198841 | −0.018620 | −0.089812 |
| | Fuel Gas, tonm/hr | −0.014202 | −0.015949 | −0.010360 | 0.460916 | 0.052480 | 0.404162 |
| | Propane, tonm/hr | −0.015557 | −0.018596 | −0.013457 | 0.555676 | 0.053406 | 0.347114 |
| | Butanes, tonm/hr | −0.027023 | −0.031837 | −0.020338 | 0.797340 | 0.067083 | 0.546223 |
| | Pentanes, tonm/hr | −0.040943 | −0.045611 | −0.035347 | 0.631281 | 0.073661 | 0.424950 |
| | C6+ Reformate, tonm/hr | 1.103049 | 1.118304 | 1.082079 | −2.644054 | −0.228009 | −1.632638 |
| | Total Fired Duty, MW | 0.067110 | 0.043439 | 0.084862 | 3.719069 | −0.198653 | 1.393028 |
| | Max inlet temperature, ° C. | −0.227360 | −0.270980 | −0.240659 | 4.794817 | 0.064259 | 1.999233 |
| | C6+ Reformate | 0.000010 | 0.000008 | 0.000071 | 0.004873 | −0.000004 | 0.000645 |
| | Specific Gravity | | | | | | |
| | Aromatics (vol %) | 0.009567 | −0.015274 | −0.016080 | 2.631239 | 0.004696 | 0.257707 |

TABLE 2A
Cross-Term Derivatives

| | | 202 | | | | | |
|---|---|---|---|---|---|---|---|
| | — | sev | sev | sev | sev | sev | sev |
| | — | PA5 | PA6 | PA7 | PA8 | PA9 | P10 |
| 204 | Hydrogen, tonm/hr | 0.000339 | 0.000329 | 0.000772 | 0.000721 | 0.000839 | 0.000870 |
| | Fuel Gas, tonm/hr | 0.002862 | 0.008132 | 0.003755 | 0.000145 | 0.000350 | 0.000254 |
| | Propane, tonm/hr | 0.002095 | 0.008313 | 0.005566 | 0.000545 | 0.000687 | 0.000501 |
| | Butanes, tonm/hr | 0.006554 | 0.013379 | 0.008401 | 0.001199 | 0.000716 | 0.000290 |
| | Pentanes, tonm/hr | 0.000310 | 0.006410 | 0.004770 | −0.001314 | −0.001198 | −0.001204 |
| | C6+ Reformate, tonm/hr | −0.012159 | −0.036562 | −0.023264 | −0.001295 | −0.001394 | −0.000710 |
| | Total Fired Duty, MW | 0.013444 | 0.019596 | 0.016726 | 0.011886 | 0.014677 | 0.014499 |
| | Max inlet temperature, ° C. | 0.007740 | 0.012758 | −0.010471 | −0.017772 | −0.009354 | −0.008253 |
| | C6+ Reformate | 0.000007 | 0.000026 | 0.000018 | −0.000003 | −0.000005 | −0.000007 |
| | Specific Gravity | | | | | | |
| | Aromatics (vol %) | 0.001917 | 0.007153 | 0.004935 | −0.002267 | −0.001546 | −0.002233 |

TABLE 2B
Cross-Term Derivatives

| | — | sev | sev | sev | sev | sev | sev |
|---|---|---|---|---|---|---|---|
| | — | P11 | N55 | N65 | N66 | N75 | N76 |
| 204 | Hydrogen, tonm/hr | 0.000517 | 0.000258 | 0.001799 | 0.000517 | 0.000403 | 0.000577 |
| | Fuel Gas, tonm/hr | 0.001277 | 0.005347 | 0.001967 | 0.000549 | 0.000079 | −0.000976 |
| | Propane, tonm/hr | 0.001078 | 0.005544 | 0.002389 | 0.001089 | 0.000878 | −0.000462 |
| | Butanes, tonm/hr | 0.000731 | 0.009334 | 0.003576 | 0.001373 | 0.000778 | −0.001275 |
| | Pentanes, tonm/hr | −0.001147 | 0.010007 | 0.001149 | −0.000277 | 0.000445 | −0.001133 |
| | C6+ Reformate, tonm/hr | −0.002456 | −0.030490 | −0.010880 | −0.003250 | −0.002582 | 0.003269 |
| | Total Fired Duty, MW | 0.007194 | 0.018475 | 0.035013 | 0.010052 | 0.008614 | 0.006871 |
| | Max inlet temperature, ° C. | −0.018938 | 0.020980 | 0.013494 | 0.002995 | −0.005526 | −0.000342 |
| | C6+ Reformate | −0.000007 | 0.000020 | 0.000005 | −0.000007 | −0.000014 | −0.000019 |
| | Specific Gravity | | | | | | |
| | Aromatics (vol %) | −0.002548 | 0.006938 | 0.006672 | −0.003513 | −0.005771 | −0.007492 |

TABLE 2C
Cross-Term Derivatives

| | | sev | sev | sev | sev | sev | sev |
|---|---|---|---|---|---|---|---|
| | | N85 | N86 | N95 | N96 | N10 | N11 |
| 206 | Hydrogen, tonm/hr | 0.001004 | 0.001006 | 0.001013 | 0.001008 | 0.001052 | 0.001329 |
| | Fuel Gas, tonm/hr | 0.000259 | 0.000268 | 0.000156 | 0.000124 | 0.000029 | 0.000132 |
| | Propane, tonm/hr | 0.000911 | 0.000937 | 0.000718 | 0.000729 | 0.000479 | 0.000608 |
| | Butanes, tonm/hr | 0.000828 | 0.000820 | 0.000393 | 0.000390 | −0.000141 | −0.000039 |
| | Pentanes, tonm/hr | 0.000247 | 0.000312 | 0.000102 | 0.000097 | −0.000256 | −0.000193 |
| | C6+ Reformate, tonm/hr | −0.003248 | −0.003343 | −0.002381 | −0.002348 | −0.001163 | −0.001837 |
| | Total Fired Duty, MW | 0.017227 | 0.015801 | 0.016740 | 0.015715 | 0.015841 | 0.018929 |
| | Max inlet temperature, ° C. | 0.007889 | 0.010645 | 0.008888 | 0.010200 | 0.009386 | 0.011178 |
| | C6+ Reformate | −0.000006 | −0.000006 | −0.000008 | −0.000008 | −0.000005 | −0.000003 |
| | Specific Gravity | | | | | | |
| | Aromatics (vol %) | −0.001135 | −0.001124 | −0.001810 | −0.001776 | −0.002501 | −0.002596 |

TABLE 2D
Cross-Term Derivatives

| | | sev | sev | sev | sev | sev | sev |
|---|---|---|---|---|---|---|---|
| | | AC6 | AC7 | AC8 | AC9 | AC0 | A11 |
| 206 | Hydrogen, tonm/hr | 0.000654 | 0.000757 | 0.001184 | 0.001164 | 0.001256 | 0.001589 |
| | Fuel Gas, tonm/hr | 0.000402 | −0.001207 | 0.000191 | 0.000096 | −0.000114 | 0.000185 |
| | Propane, tonm/hr | 0.000573 | −0.001028 | 0.000599 | 0.000438 | 0.000112 | 0.000380 |
| | Butanes, tonm/hr | 0.000694 | −0.002057 | 0.000351 | −0.000043 | −0.000596 | −0.000448 |
| | Pentanes, tonm/hr | 0.000406 | −0.000648 | 0.000912 | 0.000615 | 0.000276 | 0.000298 |
| | C6+ Reformate, tonm/hr | −0.002729 | 0.004183 | −0.003237 | −0.002271 | −0.000935 | −0.002005 |
| | Total Fired Duty, MW | 0.012651 | 0.009792 | 0.018366 | 0.017702 | 0.017931 | 0.021680 |
| | Max inlet temperature, ° C. | 0.006191 | 0.002970 | 0.015549 | 0.014670 | 0.014161 | 0.016338 |
| | C6+ Reformate | −0.000008 | −0.000020 | −0.000006 | −0.000008 | −0.000008 | −0.000002 |
| | Specific Gravity | | | | | | |
| | Aromatics (vol %) | −0.003886 | −0.007771 | −0.000888 | −0.001700 | −0.002763 | −0.002746 |

TABLE 3
Square-Term Derivatives

| | — | 302 |
|---|---|---|
| | — | sev |
| 304 | Hydrogen, tonm/hr | −0.000850 |
| | Fuel Gas, tonm/hr | 0.020934 |
| | Propane, tonm/hr | 0.021408 |
| | Butanes, tonm/hr | 0.035789 |
| | Pentanes, tonm/hr | 0.015968 |
| | C6+ Reformate, tonm/hr | −0.093249 |
| | Total Fired Duty, MW | 0.035689 |
| | Max inlet temperature, ° C. | 0.067966 |
| | C6+ Reformate Specific Gravity | 0.000161 |
| | Aromatics (vol %) | 0.060028 |

TABLE 4D

| | | | |
|---|---|---|---|
| | | Y_{base} (Hydrogen, tonm/hr), Column 106, | 7.688 |
| | | Table 1A.2 | |
| 430 | + | Sum of Linear-Terms' Impacts in Column 412, | −0.720 |
| | | Table 4A | |
| | + | Sum of Cross-Terms' Impacts in Column 420, | −0.180 |
| | | Table 4B | |
| | + | Sum of Square-Terms' Impacts in Column 428, | −0.013 |
| | | Table 4C | |
| | = | Predicted Hydrogen, tonm/hr | 6.775 |
| | | Actual Value, tonm/hr | 6.792 |
| | | Error | −0.017 |
| | | | (−0.26%) |

TABLE 4A

| | | 402 | | 404 | | 406 | 408 | | 410 | | 412 |
|---|---|---|---|---|---|---|---|---|---|---|---|
| | | Input Xi, Xi(base), Xi − Xi(base) | | | | | Linear-Terms' Impacts | | | | |
| | Nick | | | | | Xi − | | | Xi − | | |
| Variable Name | Name | Xi | − | Xi(base) | = | Xi(base) | Ai, k | × | Xi(base) | = | Product |
| C5 Paraffins, tonm/hr | PA5 | 2.122 | − | 0.081 | = | 2.041 | 0.00799 | × | 2.041 | = | 0.016 |
| C6 Paraffins, tonm/hr | PA6 | 13.675 | − | 25.260 | = | (11.584) | 0.02113 | × | −11.584 | = | −0.245 |
| C7 Paraffins, tonm/hr | PA7 | 26.541 | − | 22.990 | = | 3.551 | 0.02842 | × | 3.551 | = | 0.101 |
| C8 Paraffins, tonm/hr | PA8 | 24.019 | − | 23.569 | = | 0.450 | 0.04069 | × | 0.450 | = | 0.018 |
| C9 Paraffins, tonm/hr | PA9 | 21.444 | − | 38.704 | = | (17.261) | 0.03576 | × | −17.261 | = | −0.617 |
| C10 Paraffins, tonm/hr | P10 | 14.080 | − | 22.095 | = | (8.015) | 0.03275 | × | −8.015 | = | −0.262 |
| C11 Paraffins, tonm/hr | P11 | 5.491 | − | 1.508 | = | 3.983 | 0.03026 | × | 3.983 | = | 0.121 |
| Cyclopentane, tonm/hr | N55 | 0.350 | − | 0.239 | = | 0.111 | 0.02111 | × | 0.111 | = | 0.002 |
| C6 Cyclopentanes, tonm/hr | N65 | 3.604 | − | 6.461 | = | (2.857) | 0.04713 | × | −2.857 | = | −0.135 |
| C6 Cyclohexanes, tonm/hr | N66 | 5.814 | − | 6.362 | = | (0.549) | 0.06812 | × | −0.549 | = | −0.037 |
| C7 Cyclopentanes, tonm/hr | N75 | 9.810 | − | 8.593 | = | 1.217 | 0.04468 | × | 1.217 | = | 0.054 |
| C7 Cyclohexanes, tonm/hr | N76 | 9.954 | − | 9.337 | = | 0.617 | 0.05013 | × | 0.617 | = | 0.031 |
| C8 Cyclopentanes, tonm/hr | N85 | 8.411 | − | 8.071 | = | 0.340 | 0.04284 | × | 0.340 | = | 0.015 |
| C8 Cyclohexanes, tonm/hr | N86 | 11.022 | − | 13.549 | = | (2.527) | 0.04371 | × | −2.527 | = | −0.11 |
| C9 Cyclopentanes, tonm/hr | N95 | 7.311 | − | 11.167 | = | (3.856) | 0.03689 | × | −3.856 | = | −0.142 |
| C9 Cyclohexanes, tonm/hr | N96 | 9.554 | − | 19.851 | = | (10.297) | 0.03689 | × | −10.297 | = | −0.380 |
| C10 Naphthenes, tonm/hr | N10 | 8.703 | − | 7.954 | = | 0.749 | 0.03804 | × | 0.749 | = | 0.028 |
| C11 Naphthenes, tonm/hr | N11 | 1.535 | − | 0.419 | = | 1.116 | 0.03599 | × | 1.116 | = | 0.040 |
| C6 Aromatics, tonm/hr | AC6 | 1.713 | − | 2.639 | = | (0.926) | −0.00237 | × | −0.926 | = | 0.002 |
| C7 Aromatics, tonm/hr | AC7 | 5.745 | − | 4.267 | = | 1.478 | −0.01136 | × | 1.478 | = | −0.017 |
| C8 Aromatics, tonm/hr | AC8 | 8.841 | − | 14.534 | = | (5.694) | −0.00984 | × | −5.694 | = | 0.056 |
| C9 Aromatics, tonm/hr | AC9 | 7.202 | − | 11.908 | = | (4.706) | −0.01115 | × | −4.706 | = | 0.052 |
| C10 Aromatics, tonm/hr | AC0 | 3.237 | − | 0.390 | = | 2.847 | −0.01259 | × | 2.847 | = | −0.036 |
| C11+ Aromatics, tonm/hr | A11 | 0.235 | − | 0.052 | = | 0.183 | −0.01052 | × | 0.183 | = | −0.002 |
| Severity, C6+ Reformate RON | sev | 101.907 | − | 98.000 | = | 3.907 | 0.20734 | × | 3.907 | = | 0.810 |
| Operating Pressure, psig | PRS | 111.254 | − | 103.939 | = | 7.315 | −0.01314 | × | 7.315 | = | −0.096 |
| H₂ Recycle Ratio | HRR | 1.498 | − | 1.780 | = | (0.282) | −0.04460 | × | −0.282 | = | 0.013 |

TABLE 4B

| | | 414 | | 416 | | 418 | | 420 |
|---|---|---|---|---|---|---|---|---|
| | | Cross-Terms' Impacts | | | | | | |
| | Nick | | | Xq − | | Xsev − | | |
| Variable Name | Name | Cq, sev, k | × | Xq(base) | × | Xsev(base) | = | Product |
| C5 Paraffins, tonm/hr | PA5 | 0.000339 | × | 2.041 | × | 3.907 | = | 0.003 |
| C6 Paraffins, tonm/hr | PA6 | 0.000329 | × | −11.584 | × | 3.907 | = | −0.015 |
| C7 Paraffins, tonm/hr | PA7 | 0.000772 | × | 3.551 | × | 3.907 | = | 0.011 |
| C8 Paraffins, tonm/hr | PA8 | 0.000721 | × | 0.450 | × | 3.907 | = | 0.001 |
| C9 Paraffins, tonm/hr | PA9 | 0.000839 | × | −17.261 | × | 3.907 | = | −0.057 |
| C10 Paraffins, tonm/hr | P10 | 0.000870 | × | −8.015 | × | 3.907 | = | −0.027 |
| C11 Paraffins, tonm/hr | P11 | 0.000517 | × | 3.983 | × | 3.907 | = | 0.008 |
| Cyclopentane, tonm/hr | N55 | 0.000258 | × | 0.111 | × | 3.907 | = | 0.000 |
| C6 Cyclopentanes, tonm/hr | N65 | 0.001799 | × | −2.857 | × | 3.907 | = | −0.020 |
| C6 Cyclohexanes, tonm/hr | N66 | 0.000517 | × | −0.549 | × | 3.907 | = | −0.001 |
| C7 Cyclopentanes, tonm/hr | N75 | 0.000403 | × | 1.217 | × | 3.907 | = | 0.002 |
| C7 Cyclohexanes, tonm/hr | N76 | 0.000577 | × | 0.617 | × | 3.907 | = | 0.001 |
| C8 Cyclopentanes, tonm/hr | N85 | 0.001004 | × | 0.340 | × | 3.907 | = | 0.001 |
| C8 Cyclohexanes, tonm/hr | N86 | 0.001006 | × | −2.527 | × | 3.907 | = | −0.010 |
| C9 Cyclopentanes, tonm/hr | N95 | 0.001013 | × | −3.856 | × | 3.907 | = | −0.015 |
| C9 Cyclohexanes, tonm/hr | N96 | 0.001008 | × | −10.297 | × | 3.907 | = | −0.041 |
| C10 Naphthenes, tonm/hr | N10 | 0.001052 | × | 0.749 | × | 3.907 | = | 0.003 |
| C11 Naphthenes, tonm/hr | N11 | 0.001329 | × | 1.116 | × | 3.907 | = | 0.006 |
| C6 Aromatics, tonm/hr | AC6 | 0.000654 | × | −0.926 | × | 3.907 | = | −0.002 |
| C7 Aromatics, tonm/hr | AC7 | 0.000757 | × | 1.478 | × | 3.907 | = | 0.004 |
| C8 Aromatics, tonm/hr | AC8 | 0.001184 | × | −5.694 | × | 3.907 | = | −0.026 |
| C9 Aromatics, tonm/hr | AC9 | 0.001164 | × | −4.706 | × | 3.907 | = | −0.021 |
| C10 Aromatics, tonm/hr | AC0 | 0.001256 | × | 2.847 | × | 3.907 | = | 0.014 |
| C11+ Aromatics, tonm/hr | A11 | 0.001589 | × | 0.183 | × | 3.907 | = | 0.001 |
| Severity, C6+ Reformate RON | sev | | × | | × | | = | |
| Operating Pressure, psig | PRS | | × | | × | | = | |
| H₂ Recycle Ratio | HRR | | × | | × | | = | |

TABLE 4C

| | | 422 | | 424 | | 426 | | 428 |
|---|---|---|---|---|---|---|---|---|
| | | Square-Terms' Impacts | | | | | | |
| | Nick | | | Xsev − | | Xsev − | | |
| Variable Name | Name | Ssev | × | Xsev(base) | × | Xsev(base) | = | Product |
| C5 Paraffins, tonm/hr | PA5 | — | − | — | − | — | − | — |
| C6 Paraffins, tonm/hr | PA6 | — | − | — | − | — | − | — |
| C7 Paraffins, tonm/hr | PA7 | — | − | — | − | — | − | — |
| C8 Paraffins, tonm/hr | PA8 | — | − | — | − | — | − | — |
| C9 Paraffins, tonm/hr | PA9 | — | − | — | − | — | − | — |
| C10 Paraffins, tonm/hr | P10 | — | − | — | − | — | − | — |
| C11 Paraffins, tonm/hr | P11 | — | − | — | − | — | − | — |
| Cyclopentane, tonm/hr | N55 | — | − | — | − | — | − | — |
| C6 Cyclopentanes, tonm/hr | N65 | — | − | — | − | — | − | — |
| C6 Cyclohexanes, tonm/hr | N66 | — | − | — | − | — | − | — |
| C7 Cyclopentanes, tonm/hr | N75 | — | − | — | − | — | − | — |
| C7 Cyclohexanes, tonm/hr | N76 | — | − | — | − | — | − | — |
| C8 Cyclopentanes, tonm/hr | N85 | — | − | — | − | — | − | — |
| C8 Cyclohexanes, tonm/hr | N86 | — | − | — | − | — | − | — |
| C9 Cyclopentanes, tonm/hr | N95 | — | − | — | − | — | − | — |
| C9 Cyclohexanes, tonm/hr | N96 | — | − | — | − | — | − | — |
| C10 Naphthenes, tonm/hr | N10 | — | − | — | − | — | − | — |
| C11 Naphthenes, tonm/hr | N11 | — | − | — | − | — | − | — |
| C6 Aromatics, tonm/hr | AC6 | — | − | — | − | — | − | — |
| C7 Aromatics, tonm/hr | AC7 | — | − | — | − | — | − | — |
| C8 Aromatics, tonm/hr | AC8 | — | − | — | − | — | − | — |
| C9 Aromatics, tonm/hr | AC9 | — | − | — | − | — | − | — |
| C10 Aromatics, tonm/hr | AC0 | — | − | — | − | — | − | — |
| C11+ Aromatics, tonm/hr | A11 | — | − | — | − | — | − | — |
| Severity, C6+ Reformate RON | sev | −0.00085 | × | 3.907 | × | 3.907 | = | −0.013 |
| Operating Pressure, psig | PRS | — | − | — | − | — | − | — |
| H₂ Recycle Ratio | HRR | — | − | — | − | — | − | — |

TABLE 5

| | | Linear- | Cross- | Square- | | Rigorous | | |
|---|---|---|---|---|---|---|---|---|
| | Base | Terms' | Terms' | Terms' | Estimated | Nonlinear | Absolute | Relative |
| | Value | Impacts | Impacts | Impacts | Value | Value | Error | Error |
| Hydrogen, tonm/hr | 7.688 | −0.720 | −0.180 | −0.013 | 6.775 | 6.792 | −0.017 | −0.26% |
| Fuel Gas, tonm/hr | 3.190 | 0.684 | −0.352 | 0.320 | 3.841 | 3.810 | 0.031 | 0.82% |
| Propane, tonm/hr | 4.376 | 0.806 | −0.422 | 0.327 | 5.086 | 5.049 | 0.037 | 0.74% |
| Butanes, tonm/hr | 4.855 | 1.270 | −0.576 | 0.546 | 6.094 | 6.077 | 0.017 | 0.28% |
| Pentanes, tonm/hr | 7.757 | 3.000 | −0.175 | 0.244 | 10.826 | 10.356 | 0.470 | 4.54% |
| C6+ Reformate, tonm/hr | 232.135 | −54.629 | 1.705 | −1.424 | 177.788 | 178.326 | −0.539 | −0.30% |
| Total Fired Duty, MW | 150.512 | −18.016 | −3.603 | 0.545 | 129.438 | 130.020 | −0.582 | −0.45% |
| Max inlet temperature, ° C. | 427.312 | 12.455 | −1.287 | 1.038 | 439.517 | 439.078 | 0.438 | 0.10% |
| C6+ Reformate | 0.813 | 0.014 | 0.000 | 0.002 | 0.830 | 0.829 | 0.000 | 0.04% |
| Specific Gravity | | | | | | | | |
| Aromatics (vol %) | 65.522 | 8.236 | −0.142 | 0.916 | 74.532 | 74.324 | 0.208 | 0.28% |

Table 1A shows the 27 input variables in Row Group 116 and Table 1B shows the 10 output variables in Row Group 118. Reference model outputs can be obtained for a base point (interchangeably called “base case” herein) (Column 106) and can also be obtained for an alternative point (interchangeably called “alternate case” herein) (Column 108) for reasons explained below. Tables 1A and 1B also include results for a test case (Column 110) that will be used to demonstrate the calculations in the processes of this disclosure in a derived LP model.

Tables 1B.1, 1B.2, 1B.3, and 1B.4 combined show the base case first-order partial derivatives (∂Yₖ/∂Xᵢ, A_{i,k}, also called herein “linear-terms”) for all input variables Xᵢ(27 columns) with respect to all output variables Yₖ (10 rows). Note that the 27 columns are split into four groups of 7 columns (Table 1B.1), 7 columns (Table 1B.2), 7 columns (Table 1B.3) and 6 columns (Table 1B.4) for better presentation of data. These partial derivatives can be extracted from the ROMeo® reference tool or derived according to the method disclosed in U.S. Pat. No. 7,257,451 B2, the relevant disclosure of which is incorporated by reference in its entirety.

Tables 1C.1, 1C.2, 1C.3, and 1C.4 combined show alternate case partial derivatives for the same set of input and output variables. This alternate set of partial derivatives is used to calculate the cross-term partial derivatives (C_{p,q,k}, Equation-2 above, also called herein “cross terms”) and square-term partial derivatives (S_{r,k}, Equation-3 above, also called herein “square-terms”) in constructing the LP models of this disclosure as discussed above.

Before calculating all of the cross-term partial derivatives and the square-term partial derivatives, in certain embodiments, it can be beneficial to determine which cross-term derivatives and square-term partial derivatives to include in the final LP equation (Equation-4a or Equations-4b.1, 4b.2, 4b.3), though this is not required. The developer could generate every possible cross-term partial derivatives and square-term partial derivatives then eliminate those with an insignificant impact on the final results (e.g., those with tiny non-linear coefficients as an indicator of linear behavior). However, proactive analysis can greatly simplify the LP equation (i.e., Equation-4a or Equations-4b.1, 4b.2, 4b.3) and minimize effort to develop the LP model.

The non-linear reference model can be used to test the response of each desired output variable with respect to each input variable. In this reformer example, all output variables had a reasonably linear response to all twenty-four feed component flow rates as well as two operating conditions (reformer pressure and H₂ recycle ratio) over the expected operating window. This indicates no square-terms are required for these input variables. On the other hand, many output variables showed a non-linear response to reformer severity (“sev”) as measured by the Research Octane Number (“RON”) of the C6+ reformate. Since reformer severity impacts the yields of some feed component more than others, this example opted to include cross-terms as well as a square-term (sev²) for sev and each of the 24 feed component flow rates.

Since this particular application of the processes of this disclosure was only non-linear with respect to one input variable of interest (sev), only one alternate case is required. Inspection of Table 1A, Columns 106 and 108 confirm that sev was the only base case input variable (98) changed in the alternate case (103). If any other input variable was found to be non-linear, then another alternate case would be required with only that additional variable changing from the base case.

Desirably, the base case can be set close to expected operations. This will minimize linear and non-linear extrapolation error in the LP model. Any value can be used for the second alternate value. This example used a RON of 98 as the base value and 103 as the alternate value to reflect non-linearity over a broader portion of the 95-105 operating window. These values also allow to minimize sev extrapolation to only 3 octane points. The base case value of 98 can cover a 95-101 range with +/−3 extrapolation. The alternate value of 103 can cover a 100-106 operating range with +/−3 extrapolation.

This explains why input/output values were extracted from the reference model for both the base case and the alternate case even though only partial derivatives are required from the alternate case. If all reference model values and partial derivatives are available for both the base case and alternate case, one can change which one is the base and alternate case in the LP model, depending on whether typical operations are trending towards a minimum or maximum severity signal. Thus, in this example, the equation form, assuming Z0=0 in Equation-4b.3, can be written as follows:

$${Y}_{k} = {Y}_{k ( base )} + {\sum }_{i = 1}^{27} {A}_{i , k} \times ( {X}_{i} - {X}_{i ( base )} ) + {\sum }_{q = 1}^{24} {C}_{q , sev , k} \times ( {X}_{sev} - {X}_{sev ( base )} ) \times ( {X}_{p} - {X}_{p ( base )} ) + {S}_{sev , k} \times {( {X}_{sev} - {X}_{sev ( base )} )}^{2} \qquad ( Eq - 14 )$$

where i represents all 27 input variables and q represents all 24 feed component flow that have cross-terms with the sev input.

With the equation form now known, all base values and coefficient values are then determined. All X_{p(base)} and Y_{k(base)} values come directly from Column 106 of Tables 1A.1 and 1A.2. In addition, A_{i,k} is the partial derivative of Yₖ with respect to Xᵢ at the base point. These values come directly from Tables 1B.1, 1B.2, 1B.3, and 1B.4.

The values for C_{q,sev,k} are derived from the base case and alternate case partial derivatives as shown in Equation-2. Applying Equation-2 to this example yields

$${C}_{q , sev , k} = \frac{\partial \frac{\partial {Y}_{k}}{\partial {X}_{q}}}{\partial {X}_{sev}} = \frac{\frac{\partial {Y}_{k}}{\partial {X}_{q ( base + h )}} - \frac{\partial {Y}_{k}}{\partial {X}_{q ( base )}}}{{X}_{sev ( base + h )} - {X}_{sev ( base )}} \qquad ( Eq - 15 )$$

As a sample calculation, let Yₖ=Hydrogen Production (“Hydrogen,” in metric tons per hour, tonm/hr) and let q=PA5 (C5 Paraffins). In this scenario,
∂Yₖ/∂X_{PA5(base+h)}=0.009685 (intersection of Column 130 and Row 132 in Table 1C.1);
∂Yₖ/∂X_{PA5(base)}=0.007991 (intersection of Column 120 and Row 122 in Table 1B.1);
X_{sev(base+h)}=103 (intersection of “Severity, C6+ Reformate RON” row and Column 108 of Table 1A.1); and
X_{sev(base)}=98 (intersection of “Severity, C6+ Reformate RON” row and Column 106 of Table 1A.1)

Substituting these values into Eq-15 yields

$${C}_{PA 5 , sev , k} = ( 0.009685 - 0.007991 ) / ( 103 - 98 ) = 0.000339$$

as shown at the intersection of Column 202 and Row 204 in Table 2A.

Repeating this calculation for all 24 input component flow rates and 10 output variables generates all C_{q,sev,k} as shown in Tables 2A, 2B, 2C, and 2D.

The value for S_{sev,k} is derived per Equation-3. Applying Equation-3 to this example yields

$${S}_{sev , k} = \frac{{\partial }^{2} {X}_{sev}}{\partial {X}_{sev}^{2}} = \frac{\frac{\partial {Y}_{k}}{\partial {X}_{sev ( base + h )}} - \frac{\partial {Y}_{k}}{\partial {X}_{sev ( base )}}}{2 \times ( {X}_{sev ( base + h )} - {X}_{sev ( base )} )} ; \qquad ( Eq - 16 )$$

Again, let Yₖ=Hydrogen, tonm/hr to yield
∂Yₖ/∂X_{sev(base+h)} 0.198841 (intersection of Column 134 and Row 136 in Table 1C.4);
∂Yₖ/∂X_{sev(base)} 0.207340 (intersection of Column 124 and Row 126 in Table 1B.4);
X_{sev(base+h)}=103 (intersection of “Severity, C6+ Reformate RON” and Column 108 of Table 1A.1); and
X_{sev(base)} 98 (intersection of “Severity, C6+ Reformate RON” and Column 106 of Table 1A.1).

Substituting these values into Eq-16 yields

$${S}_{sev , k} = ( 0.198841 - 0.20734 ) / ( 2 * ( 103 - 98 ) = - 0.00085$$

as shown at the intersection of Column 302 and Row 304 in Table 3.

Repeating this calculation for the other 9 output variables generates S_{sev,k} for all output variables as shown in Table 3.

All base values, the cross-terms, and the square-term have now been determined for Eq-14, completing the constructing the LP model equation. Eq-14 can now be applied to other sets of input variables, Xᵢ, as a predictive model.

For this sample calculation, the model will be applied to the test case shown in Column 110 of Tables 1A.1 and 1A.2. This test case was chosen as it represents larger swings than would normally be expected. As shown in Column 110 of Table 1A.1:
1. Feed component flow rates change from −52% to +2532% (total feed rate changes −19% from maximum rates to near minimum rates);
2. Reformate RON changes by 4%, which is larger than the max +/−3 targeted;
3. Operating pressure changes 7%; and
4. H₂ recycle ratio changes −16%.

These large changes in reactor feed rate, reactor feed composition, and reactor operating conditions will challenge the rangeability of the derived LP model. For consistency, this example calculation will continue to use Yₖ=Hydrogen, tonm/hr (a variable that is strongly impacted by reformer severity and aromatics formation).

Tables 1A.1 and 1A.2, Column 110 show the values for all 27 input variables (Row Group 116) and 10 output variables to be predicted (Row Group 118). The expected hydrogen production obtained by using the rigorous first-principles-based non-linear reference model is 6.792 tonm/hr, a 12% reduction from the base value of 7.688 tonm/hr. The processes of this disclosure can be used to predict this nonlinear reformer yield by starting from the base value of 7.688 tonm/hr and applying linear, cross-term, and square-term shifts.

The complete calculation is shown in Tables 4A, 4B, 4C, and 4D. To clarify this calculation, this particular application will use Eq-14 above to predict all product values.

Looking through the details of this equation to calculate Hydrogen Production,
Y_{k(base)} is found in Table 1A.2, Column 106, Row Group 118. It is replicated in Table 4D, Row Group 430 of the sample calculation.
A_{i,k} values are found in Tables 1B.1, 1B.2, 1B.3, and 1B.4, Rows 122 and 126. They are replicated in Table 4A, Column 408 of the sample calculation.
Xᵢ values are found in Table 1A, Column 110, Row Group 116. They are replicated in Table 4A, Column 402 of the sample calculation.
Xᵢ(base) values are found in Table 1A, Column 106, Row Group 116. They are replicated in Table 4A, Column 404 of the sample calculation.
Xᵢ−X_{i(base)} deltas are calculated in Table 4A, Column 406. They are replicated in Columns 410 to show all calculations.
The 27 A_{i,k}×(Xᵢ−X_{i(base)}) calculations (also called “linear shifts”) are found in Table 4A, Column 412, with the sum of all values included in Table 4D.
C_{q,sev,k} values are found in Tables 2A, 2B, 2C, and 2D, Rows 204 and 206. They are replicated in Table 4B, Column 414 of the sample calculation.
X_{q}−X_{q(base)}=Xᵢ−X_{i(base)} for the first 24 variables. These values can be found in Table 4B, Column 416.
Xₛₑᵥ−X_{sev(base)}=Xᵢ−X_{i(base)} for the Severity variable. This value is repeated in Tables 4B and 4C, Columns 418, 424, and 426.
The 24 C_{q,sev,k}×(Xᵢ−X_{i(base)})×(Xₛₑᵥ−X_{sev(base)}) calculations (also called “cross-term shifts”) are found in Table 4B, Column 420, with the sum of all values included in Table 4D.
Sₛₑᵥ is found in Table 3, Column 302, Row 304. It is replicated in Table 4C, Column 422.
S_{sev,k}×(Xₛₑᵥ−X_{sev(base)})×(Xₛₑᵥ−X_{sev(base)}) (also called “square shifts”) is found in Table 4C, Column 428, with the sum totals included in Table D.

The calculations described above and shown in Tables 4A, 4B, 4C, and 4D simplify Eq-14 to

$${Y}_{k} = {Y}_{k ( base )} + Sum of Linear Shifts + Sum of Cross - Term Shifts + Square - Term Shift = 7.688 + ( - 0.72 ) + ( - 0.18 ) + ( - 0.013 ) = 6.775 ( tonm / hr )$$

as shown in Table 4D, Row Group 430.

This predicted value using the LP model of this disclosure of 6.775 tonm/hr comes within 0.26% of the value obtained by using the rigorous first-principles-based non-linear reference model (6.792 tonm/hr), despite large shifts in input variables with known non-linearity, as shown in Table 4D. More importantly, this prediction was accomplished without regression techniques that are based on correlation rather than causation. This yields a more understandable and, therefore, more trustworthy model that preserves thermodynamic and kinetic fundamentals.

Table 5 shows prediction for all ten of the predicted output variables using the derived model of this disclosure. Nine of the ten variables were predicted within 1% accuracy relative to their values obtained by using the rigorous first-principles-based non-linear reference model (“Rigorous Nonlinear Value” in Table 5). The tenth variable, Product Pentanes, was an outlier at 4.5% error. This suggests additional nonlinearity that may be addressed by additional 2^{nd}-order terms or perhaps even a higher-order equation. Analysis of additional test cases and/or sensitivity cases with the rigorous reference model could help to determine what these non-linear variables might be. In this case, it is well within desired tolerance of 10% and deemed acceptable.

Thus, the above model can be reliably used in optimizing the reformer. Vector mathematical operations can be conveniently used for that purpose as described earlier in this application.

As can be seen above, the construction of the non-linear LP model of this disclosure makes use of a non-linear first-principles-based reference model on a limited basis to calculate the first-order partial derivatives, the cross-term partial derivatives, and the square-term partial derivatives. Once these derivatives are obtained, they can be used for calculating values of a large number of output variables without further using the first-principles-based reference model from varied values of a large number of input variables, very efficiently, preferably using linear algebra techniques.

### Example 2 (Comparative)

The same reformer of Example 1 was modeled using the first-principles-based non-linear reference model described above in Example 1. Due to the rigor of the first-principles-based model, the modeling results from Example 2 were used as benchmarks to evaluate the accuracy of the simulation models of Examples 1, 3, and 4. As described above, calculation using first-principles-based models requires intensive computing resource, especially if a large number of variables are involved. Comparatively, the LP model of Example 1 above, constructed with the aid of limited use of the first-principles-based non-linear reference model, is much more efficient in calculating values of multiple output variables, especially if large numbers of input variables and output variables are involved.

### Example 3 (Comparative)

The same reformer of Example 1 was modeled using the LP model as described in U.S. Pat. No. 7,257,451, representable by Equation-6 above.

### Example 4 (Comparative)

The same reformer was modeled using an LP model constructed using regression techniques available in the prior art, representable by Equation-7 above.

### Discussions of Modelling Results

Select modelling data from Examples 1, 2, 3, and 4 are presented and contrasted in the appended figures.

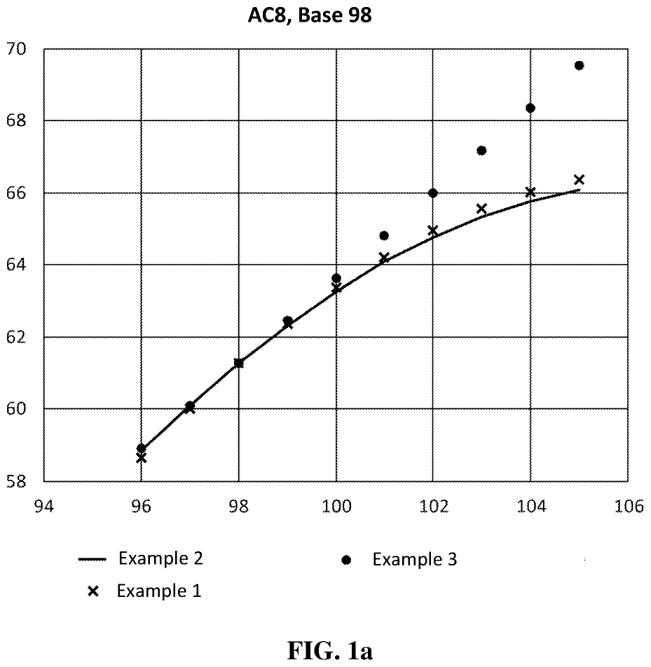

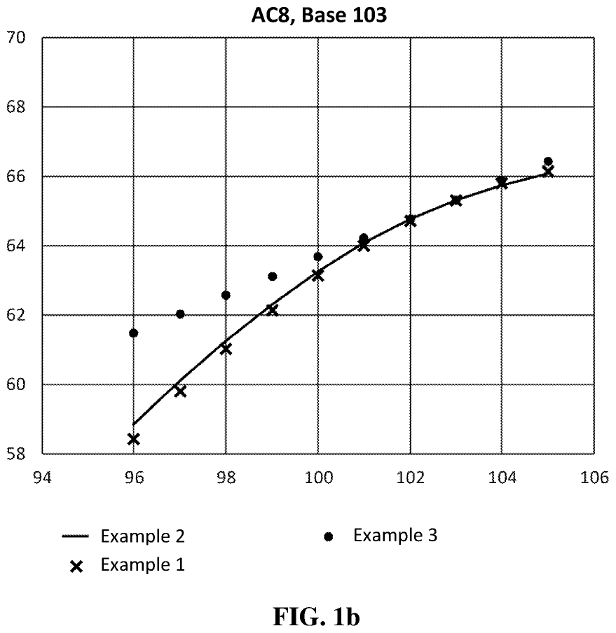

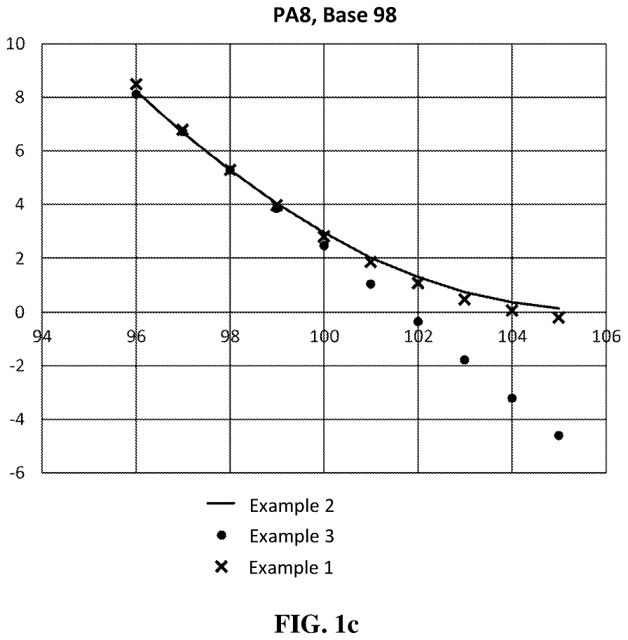

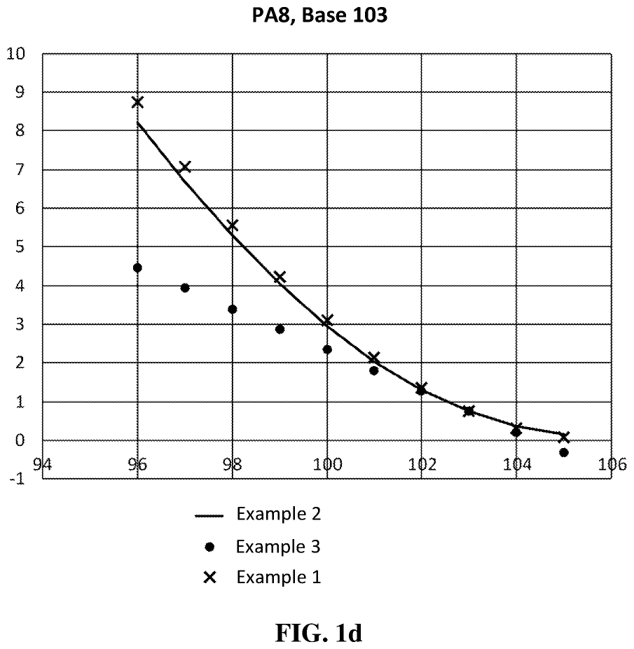

### FIGS. 1a, 1b, 1c, and 1d Comparing Examples 1, 2, and 3

FIGS. 1a and 1b show and contrast one output variable, C8 aromatic hydrocarbon (“AC8”) yield (wt %) in the vertical axis, as a function of the research octane number (“RON”) of the reformate in the horizontal axis, obtained in Examples 1, 2, and 3, using a base point having a RON of 98 (FIG. 1a) or 103 (FIG. 1b), respectively.

FIGS. 1c and 1d show and contrast one output variable, C8 paraffinic hydrocarbon (“PA8”) yield (wt %) in the vertical axis, as a function of the research octane number (“RON”) of the reformate in the horizontal axis, obtained in Examples 1, 2, and 3, using a base point having a RON of 98 (FIG. 1c) and 103 (FIG. 1d), respectively.

The data underlying curves of Example 2 in FIGS. 1a, 1b, 1c, and 1d are generated by a fundamental, first-principles-based, nonlinear reformer LP model, and therefore are considered as accurate and used as benchmark to evaluate the performance of the simulation models of Examples 1, 3, and 4. While it is feasible, and sometimes desirable to use such fundamental, first-principles-based model to simulate cases with relatively small number of input variables and output variables such as the cases examined in Example 2 in this disclosure, in cases involving significantly larger number of variables, the resources required to complete the calculations using such models of Example 2 can be prohibitively expensive. By taking advantages of vector operations, the models of Examples 1, 3, and 4 can be much faster than the model of Example 2 in simulating cases with large number of variables.

The comparison of data of Example 3 against the curves of Example 2 in FIGS. 1a, 1b, 1c and 1d clearly shows the linear model of Example 3 is inadequate to predict nonlinear reformer yields and can only cover half of the operating range accurately. In addition, linear extrapolations in Example 3 lead to negative yield predictions in FIGS. 1c and 1d, which would cause an optimization tool to crash. However, in all of FIGS. 1a, 1b, 1c, and 1d, the data in Example 1 track very well with the rigorous data of Example 2 over the full operating range regardless of the base point selected. Thus, linear derivation LP models representable by Equation-6 only have medium rangeability and are inadequate to cover broad nonlinearity of the reformer. In addition, while linear derivation underlying the simulation model of Example 3 is fundamental and easy to understand, it lacks the fundamentals to represent a truly nonlinear problem.

### Table 6 Comparing Examples 1 and 4

Table 6 below shows first-order partial derivatives of reformer yields with respect to change of only one input variable, benzene feed rate (“BFR”), of 1 kilo-barrels per day (“KBD”) in Examples 1 and 4, i.e., A_{BFR,k} in Eq-14 in Example 1, and R_{BFR,k} in Equation-7 in Example 4, above). A_{BFR,k} and R_{BFR,k} are indicative of the responses of the various reactor output variables pursuant to the modelling approaches of Examples 1 and 4, respectively.

TABLE 6
Responses to 1 KBD of BFR

| | Example 1 | Example 4 |
|---|---|---|
| | (Inventive) | (Comparative) |
| Change of Output Variable | A_{BFR, k} | R_{BFR, k} |
| HYDROGEN | 0.00 | (0.01) |
| FUEL GAS (FOEB) | (0.00) | 0.00 |
| PROPANE (KBD) | (0.01) | (0.10) |
| I-BUTANE (KBD) | (0.01) | (0.05) |
| N-BUTANE (KBD) | (0.01) | (0.05) |
| Pentanes (KBD) | (0.01) | (0.01) |
| Reformate (KBD) | 1.04 | 1.19 |
| C6 P + N to Aromatic Feed | 0.04 | 0.29 |
| C7 P + N to Aromatic Feed | 0.02 | 0.24 |
| C8 Non-Aromatic Balance | 0.01 | (0.04) |
| C9 Non-A Balance | 0.00 | (0.08) |
| C10+ Non-A Balance | 0.00 | (0.11) |
| Benzene | 0.96 | 0.93 |
| Toluene Balance | (0.01) | (0.11) |
| Ethylbenzene in C6+ reformate | 0.00 | (0.16) |
| p-Xylene in C6+ reformate | 0.00 | 0.06 |
| m-Xylene in C6+ reformate | 0.00 | 0.11 |
| o-Xylene in C6+ reformate | 0.00 | (0.01) |
| C9 Balance | 0.01 | 0.04 |
| C10+ Balance | 0.01 | 0.02 |

The simulated reformer in Table 6 receives heavy naphtha (C6-C10 range) and allows the following several key reactions to occur:
Paraffins and naphthenes (“P+N”) are converted to aromatics, and cracked to produce lighter P+N molecules (mostly C1-C5 molecules) and hydrogen; and
C7-C10 aromatics are converted into lighter aromatics and C1-C5 molecules. Aromatics are molecules with stable benzene rings and varying hydrocarbon side chains (i.e., alkyl groups). Because the benzene ring is a highly stable structure, the primary Aromatics reaction is for alkyl side chains to be separated/cracked from C7-C10 aromatics to form lighter aromatics and C1-C5 molecules.

Table 6 shows that in Example 4, the regression modelling technique predicted that an increase of 1 KBD of BFR would yield 1.19 KBD of reformate quantity change (a 19% volume increase), which defies reaction kinetics. A 19% volume increase would only occur by cracking larger, higher-density reformate molecules to smaller, lower-density reformate molecules. However, benzene itself has no alkyl group that can be sheared off to yield a lighter, lower-density (higher volume) molecule. Nor is benzene expected to crack to form smaller C1-C5 hydrocarbons under the reactor conditions. The addition of 1 KBD BFR is not expected to materially alter the cracking reactions of the other components in the feeds. In Table 6, Example 4 also predicted changes in the C1-C5 yields and C7-C10 yields, which again should not happen since benzene undergoes minimal reaction. Clearly, the regression-based model of Equation-7 exemplified in Example 4 does not reflect true process fundamentals. The secondary responses predicted by it, if relied on, can drive an optimization model to make decisions that are not intuitive.

In stark contrast, as is clearly shown in Table 6, the inventive Example 1, utilizing a non-linear derivation-based model, provided partial derivatives that match the expected kinetics of reformer yields. The only significant yield impact was that the presence of additional benzene (a key reformer product) in reformer feed suppressed the conversion of P+N feed molecules to benzene, which is consistent with reaction equilibrium phenomena. This led to a slight volume increase (4%) that can be explained by the additional C6 P+N molecules that did not convert to higher-density benzene molecules. A non-linear, first-principles ROMeo® model per Example 2 predicted that the 1 KBD additional benzene largely passes through the reformer, with minimal impact on other output variables, consistent with the result of Example 1. Therefore, compared to the regression-based model of the prior art, the derivation-based model of the processes in this disclosure reflect process fundamentals much better.

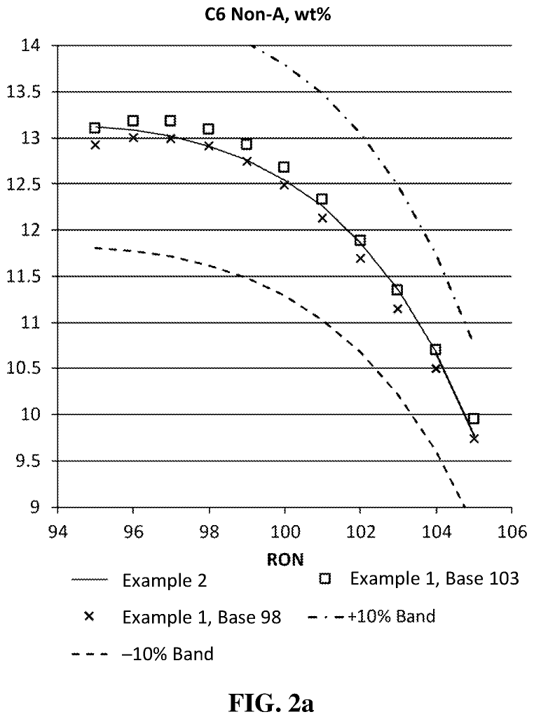

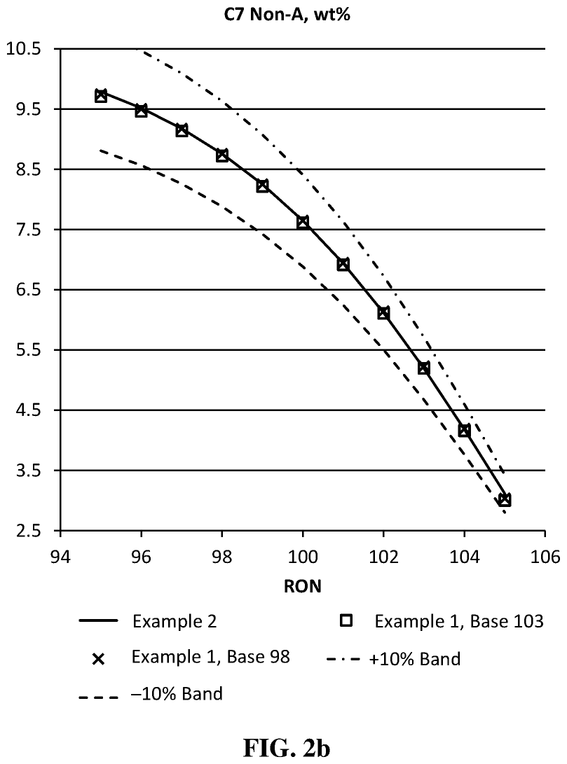

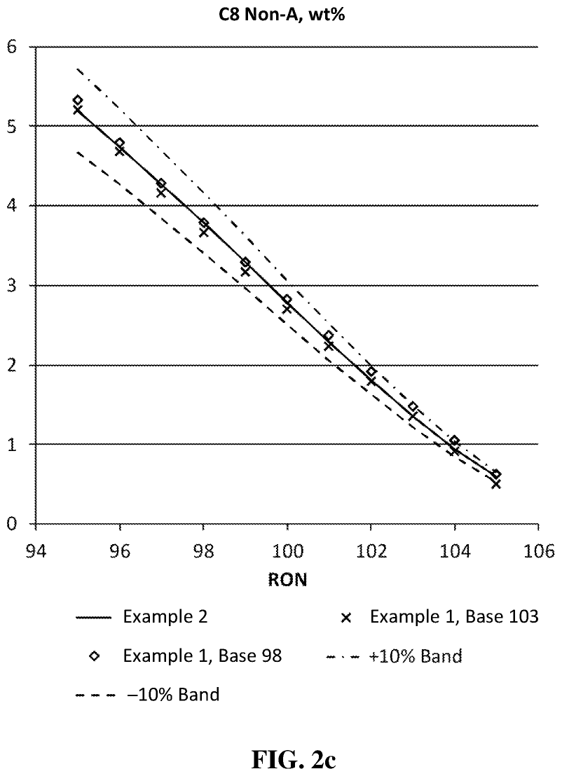

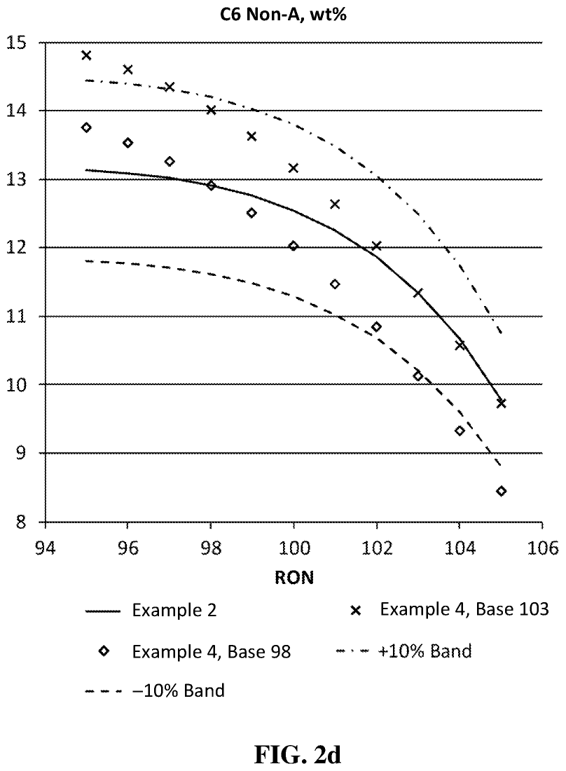

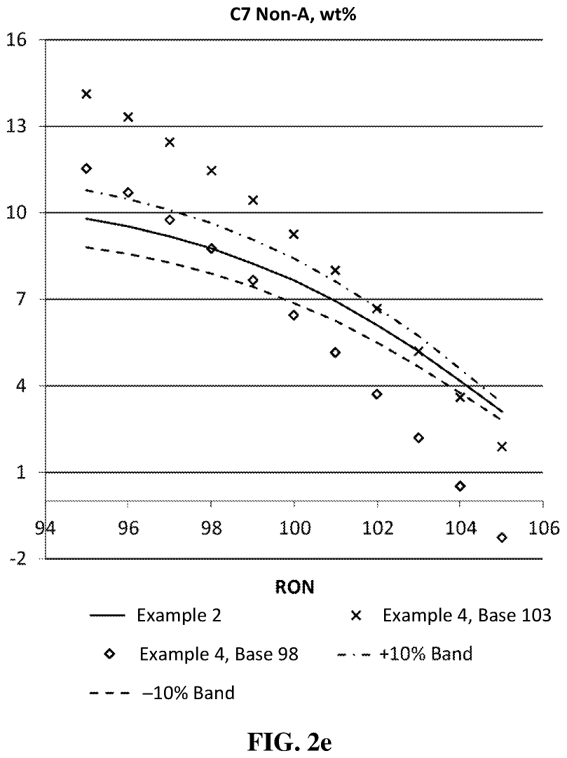

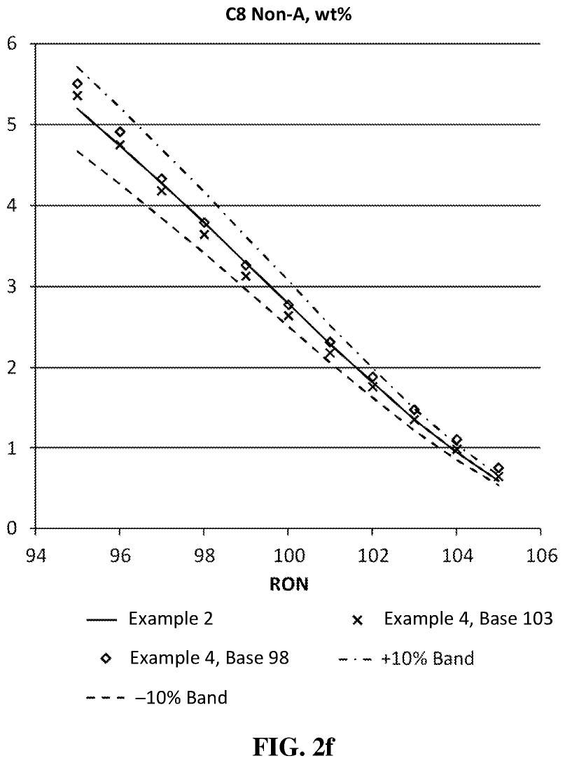

### FIGS. 2a, 2b, 2c, and 2d Comparing Examples 1, 2, and 4

FIG. 2a shows one output variable, C6 non-aromatic hydrocarbon (“C6 Non-A”) yield (wt %) in the vertical axis, as a function of the research octane number (“RON”) of the reformate in the horizontal axis, obtained in Examples 1 and 3, using a base point having a RON of 98 or a base point having a RON of 103.

FIG. 2b shows one output variable, C7 non-aromatic hydrocarbon (“C7 Non-A”) yield (wt %) in the vertical axis, as a function of the RON of the reformate in the horizontal axis, obtained in Examples 1 and 3, using a base point having a RON of 98 or a base point having a RON of 103.

FIG. 2c shows one output variable, C8 non-aromatic hydrocarbon (“C8 Non-A”) yield (wt %) in the vertical axis, as a function of the RON of the reformate in the horizontal axis, obtained in Examples 1 and 3, using a base point having a RON of 98 or a base point having a RON of 103.

FIG. 2d shows one output variable, C6 non-aromatic hydrocarbon (“C6 Non-A”) yield (wt %) in the vertical axis, as a function of the research octane number (“RON”) of the reformate in the horizontal axis, obtained in Examples 2 and 4, using a base point having a RON of 98 or a base point having a RON of 103.

FIG. 2e shows one output variable, C7 non-aromatic hydrocarbon (“C7 Non-A”) yield (wt %) in the vertical axis, as a function of the RON of the reformate in the horizontal axis, obtained in Examples 2 and 4, using a base point having a RON of 98 or a base point having a RON of 103.

FIG. 2f shows one output variable, C8 non-aromatic hydrocarbon (“C8 Non-A”) yield (wt %) in the vertical axis, as a function of the RON of the reformate in the horizontal axis, obtained in Examples 2 and 4, using a base point having a RON of 98 or a base point having a RON of 103.

Regression correlations cannot be developed without first creating a design of experiments (“DoE”). First, the developer defines the operating range for all independent input variables. Next, the developer designs and runs a large set of cases (DoE) that moves all independent variables-sometimes individually, sometimes in combination—in an attempt to cover all potential operating scenarios evenly. Last, the developer uses results from that large set of cases to regress coefficients for the nonlinear correlation. If not done well, this is problematic for regression model predictions. Consider a plant that runs three discrete operating scenarios. If one scenario is heavily weighted in the DoE, then the regressed model will be more accurate for that scenario and less accurate for other scenarios. However, optimization models need to represent all potential scenarios equally for correct incremental decisions. Expand this from three discrete scenarios to our test example—a reformer with 27 independent input variables that operate over a continuum of conditions. It becomes readily apparent that the potential combinations become difficult to manage and even more difficult to weight equally. Even if a developer does a perfect job setting up a DoE, there is an issue outside the developer's control. Process units are not static, and operating windows change over time. For this reason, a “perfect” regression over a predefined DoE range can become invalid if the process operating window expands beyond that DoE window. Therefore, the rangeability of the conventional regression-based models, such as representable by Equation-7 above, is limited.

In contrast, the deviation-based model in the processes of this disclosure does not depend on a pre-defined operating window. It starts with a base point and extrapolates based on fundamental first-, second- and optional higher-order derivatives. This eliminates the data setup flaws/limitations of common regression techniques and can extrapolate as far as the square-term and optional higher-order equation is valid for the process unit.

An example is illustrated in FIGS. 2a, 2b, 2c, 2d, 2e, and 2f. A regression model was built for a RON range of 94-103 per comparative Example 4, but the operating window widened to 105 RON over time. In some cases, the regression extrapolated well (e.g., C8 Non-A, see FIG. 2f). In other cases, the regression extrapolated to negative yields (e.g., C7 Non-A, see FIG. 2e), which would cause an optimization model to crash or take sub-optimal steps to converge. By comparison, the fundamental derivation techniques of inventive Example 1 were able to represent the full range well and the results were independent of whether a base point of 98 or 103 was selected (e.g., C6 Non-A, C7 Non-A, and C8 Non-A, see, FIGS. 2a, 2b, and 2c). By contrast, the rangeability of the regression results per comparative Example 4 was highly dependent on the base point selected (e.g., C6 Non-A, C7 Non-A, see, FIGS. 2d and 2e).

Regression coefficients are statistically estimated and, hence, are not understandable. It is well documented that there are mathematical pitfalls in regression analyses, yet regression remains the common technique for developing nonlinear correlations. These pitfalls impact the ability to understand regression coefficients. While regression may yield good absolute answers, the individual incremental shifts that drive optimization models may be inaccurate. This makes focused sensitivity cases difficult to understand. By contrast, since the partial derivatives in the models in the processes of this disclosure are based on first principles, they have high understandability, and can be used to inform further enhancement of the model, e.g., by adding square-term or higher-order derivation terms.

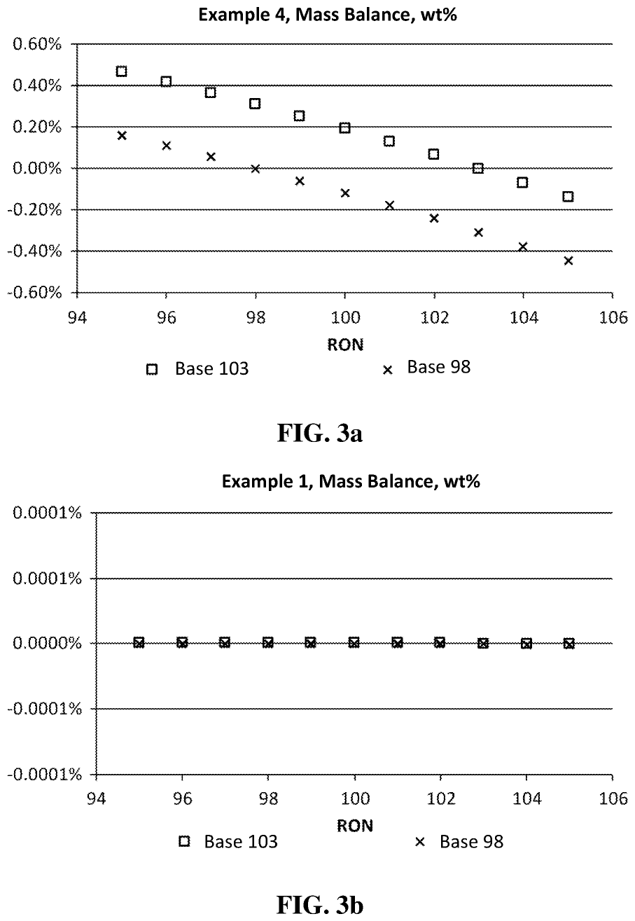

### FIGS. 3a and 3b Comparing Examples 1 and 4

An additional problem with regression techniques is the lack of forced mass balance. It is incumbent on the developer to check that regression coefficients close mass balance reasonably well. If mass balance is not closed, then it can be challenging to determine how to close mass balance. Either all error can be placed in a single product that is calculated by difference or regression coefficients can be artificially adjusted to close mass balance. In the reformer example, it was found that the existing regression model of Example 4 did not preserve mass balance. As shown in FIG. 3a, mass balance in the regression model per Example 4 varied by about 0.6 wt % across the operating range. Even worse, the mass balance error has a directional bias that would artificially skew optimization predictions to lower RON than may be optimal. By contrast, FIG. 3b shows that fundamental derivation of the model of the inventive Example 1 preserves mass balance within 1e-06, which was the convergence tolerance of the reference model used.

From the above examples, the advantages of the inventive processes are clearly established over those available in the prior art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A process for approximately determining the value of one or more of m output variables Yₖ of an industrial system, an industrial process, and/or an industrial product with a non-linear behavior as a function of n input variables Xᵢ, wherein i, m, and n are independently each a positive integer, 1≤k≤m, 1≤i≤n, and the process comprises:
(I) selecting a base point having a predetermined value of X_{i(base)} for each input variable Xᵢ;
(II) obtaining an output value of Y_{k(base)} at the base point from the predetermined values of X_{i(base)} by using a non-linear reference tool;
(III) obtaining a first-order partial derivative, A_{i,k}, of Yₖ with respect to an Xᵢ at the base point, where
$${A}_{i , k} = \frac{\partial {Y}_{k}}{\partial {X}_{i}} ; \qquad ( Equation - 1 )$$
(IV) where n≥2, optionally obtaining a cross-term partial derivative, C_{p,q,k}, of Yₖ with respect to a pair of two input variables Xᵢ at the base point, where
$${C}_{p , q , k} = \frac{\partial \frac{\partial {Y}_{k}}{\partial {X}_{p}}}{\partial {X}_{q}} = \frac{\frac{\partial {Y}_{k}}{\partial {X}_{p ( base + h )}} - \frac{\partial {Y}_{k}}{\partial {X}_{p ( base )}}}{{X}_{q ( base + h )} - {X}_{q ( base )}} ; \qquad ( Equation - 2 )$$
where:
Xₚ and X_{q} are the pair of two input variables Xᵢ, p and q are positive integers, p≤n, q≤n;
X_{p(base+h)} is value of Xₚ at an alternative point differing from the base point, preferably in the vicinity of the base point;
X_{q(base+h)} is value of X_{q} at an alternative point differing from the base point, preferably in the vicinity of the base point;
$$\frac{\partial {Y}_{k}}{\partial {X}_{p ( base + h )}}$$
is first-order partial derivative of Yₖ with respect to Xₚ at a deviation point differing from the base point, preferably in the vicinity of the bae point; and
∂Yₖ/∂X_{p(base+h)} is first-order partial derivative of Yₖ with respect to Xₚ at the base point;
(V) optionally obtaining a square-term partial derivative, S_{r,k}, of Yₖ with respect to an input variable Xᵣ, at the base point, where:
$${S}_{r , k} = \frac{{\partial }^{2} {X}_{r}}{\partial {X}_{r}^{2}} = \frac{\frac{\partial {Y}_{k}}{\partial {X}_{r ( base + h )}} - \frac{\partial {Y}_{k}}{\partial {X}_{r ( base )}}}{2 \times ( {X}_{r ( base + h )} - {X}_{r ( base )} )} ; \qquad ( Equation - 3 )$$
where:
r is a positive integer, and 1≤r≤n;
X_{r(base+h)} is value of Xₚ at an alternative point differing from the base point, preferably in the vicinity of the base point;
$$\frac{\partial {Y}_{k}}{\partial {X}_{r ( base + h )}}$$
is first-order partial derivative of Yₖ with respect to Xᵣ at the alternative point; and
(VI) calculating the value of Yₖ according to the following:
(VI.1) where n=1, and step (V) is carried out:
$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + Z 0 ; \qquad ( Equation - 4 a )$$
and
(VI.2) where n≥2, and
(VI.2a) where step (IV) is carried out and step (V) is optionally carried out:
$${Y}_{k} = {Y}_{k ( base )} + {\sum }_{i = 1}^{u} {A}_{i , k} \times ( {X}_{i} - {X}_{i ( base )} ) + {\sum }_{p = 1}^{v - 1} ( {\sum }_{q = p + 1}^{v} {C}_{p , q , k} \times ( {X}_{p} - {X}_{p ( base )} ) \times ( {X}_{q} - {X}_{q ( base )} ) ) + Z 0 ; \qquad ( Equation - 4 b \text{.1} )$$
or
(VI.2b) where step (IV) is optionally carried out and step (V) is carried out:
$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + Z 0 ; \qquad ( Equation - 4 b \text{.2} )$$
or
(VI.2c) where both steps (IV) and step (V) are carried out:
$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + {\sum }_{p = 1}^{v - 1} ( {\sum }_{q = p + 1}^{v} {C}_{p , q , k} \times ( {X}_{p} - {X}_{p ( base )} ) \times ( {X}_{q} - {X}_{q ( base )} ) ) + Z 0 ; \qquad ( Equation - 4 b \text{.3} )$$
where u, v, and w are positive integers, u≤n, v≤n; and w≤n; and Z0 is a constant.

2. The process of claim 1, wherein Z0 is zero.

3. The process of claim 1, wherein:
in step (VI), case (VI.2a), step (V) is not carried out; and/or
in step (VI), case (VI.2b), step (IV) is not carried out.

4. The process of claim 1, having at least one of the following features:
(i) the input variables Xᵢ(1≤i≤u), Xₚ (1≤p≤v−1), X_{q}(2≤q≤v), or Xᵣ (1≤r≤w) values are provided in a vector;
(ii) the A_{i,k} values are provided in a matrix;
(iii) the C_{p,q,k} values are provided in a matrix;
(iv) the S_{r,k} values are provided in a matrix;
(v) at least one of the Xᵢ−X_{i(base)}, Xₚ−X_{p(base)}, X_{q}−X_{q(base)} or Xᵣ−X_{r(base)} values is provided in a vector;
(vi) the (Xᵣ−X_{r(base)})² values are provided in a vector; and
(vii) step (VI) is carried out using matrix multiplication to calculate output variables Yₖ values and the process further comprises providing the Yₖ values in a vector.

5. The process of claim 1, wherein step (II) comprises:
(IIa) creating a non-linear reference model of the industrial system, the industrial process, and/or the industrial product by using the non-linear reference tool; and
(IIb) obtaining the output value of Y_{k(base)} from the predetermined values of X_{i(base)} using the non-liner reference model.

6. The process of claim 5, wherein step (IIb) comprises providing the X_{i(base)} values in a vector and generating the output values of Y_{k(base)} in a vector.

7. The process of claim 1, wherein u=v=w=n.

8. The process of claim 7, having at least one of the following features:
(i) the n input variables Xᵢ are provided in a vector having n dimensions;
(ii) the A_{i,k} values are provided in a matrix having n×m dimensions;
(iii) the C_{p,q,k} values are provided in a matrix having [n×(n−1)]×m dimensions;
(iv) the S_{r,k} values are provided in a matrix having n×m dimensions;
(v) at least one of the Xᵢ−Xᵢ(base), Xₚ−X_{p(base)}, X_{q}−X_{q(base)} or Xᵣ−X_{r(base)} values are provided in a vector having n dimensions;
(vi) the (Xᵣ−X_{r(base)})² values are provided in a vector having n dimensions; and
(vii) step (VI) is carried out using matrix multiplication to calculate output variables Yₖ values and the process further comprises providing the Yₖ values in a vector having m dimensions.

9. The process of claim 1, wherein the values of A_{i,k} is obtained using the non-linear reference tool.

10. The process of claim 1, comprising:
creating a non-linear reference model of the industrial system, the industrial process, and/or the industrial product using the non-linear reference tool; and
obtaining the values of A_{i,k} using the non-linear reference model.

11. The process of claim 1, wherein the input variables Xᵢ include at least one of the following:
a unit temperature; a unit pressure; a unit residence time; a quantity of an overall feed mixture; a quantity or a concentration of one or more major component of the feed mixture; a quantity or a concentration of one or more non-negligible contaminant in the feed mixture; a total quantity of catalyst in the reaction; a quantity or concentration of one or more catalytically effective component in the catalyst; a unit energy efficiency; a quantity or concentration of a product in a stream; and a quantity or a concentration of one or more non-negligible contaminant in a product-containing stream.

12. The process of claim 1, wherein the output variables Yₖ include at least one of the following:
an overall quantity or yield of the industrial product; an overall quantity or yield of a byproduct; an overall quantity or yield of an intermediate product; a quantity, a concentration, or a yield of one or more major component of the industrial product; a quantity or a concentration of one or more non-negligible contaminant in the industrial product; a quantity of total energy consumed; a quantity of energy consumed by an individual equipment; a metallurgic limitation; a capacity limitation; a heat duty of an equipment; and a power consumption of an equipment.

13. The process of claim 1, wherein the industrial system comprises and/or industrial process operates one or more of the following: a feed pre-treatment sub-system; a reactor; a pump; a compressor; an expander; a heat exchanger; a distillation column; a flash drum; a boiler; a furnace; an electric power supply; and a shaft power generator.

14. The process of claim 1, wherein the industrial system comprises and/or the industrial process operates one or more of the following: a crude distillation column; a fluid catalytic converter; a hydroprocessing unit; a reformer; an extraction unit; an adsorption separation unit; a petroleum refinery; a steam cracking furnace; a process gas compressor; a primary fractionation column; a naphtha hydroprocessing unit; an acetylene converter; a refrigeration unit; a cryogenic separation unit; an olefins recovery section; an olefins production plant; and a chemical production plant.

15. A process for optimizing an industrial system, an industrial process, and/or an industrial product with a non-linear behavior having one or more of m output variable Yₖ as a function of n input variables Xᵢ, where i, m, and n are each independent a positive integer, 1≤k≤m, 1≤i≤n, and the process comprises:
(A) determining a first set of value of one or more of Yₖ at a first set of Xᵢ by:
(A-I) selecting a base point having a predetermined value of X_{i(base)} for each input variable Xᵢ;
(A-II) obtaining an output value of Y_{k(base)} from the predetermined values of X_{i(base)} by using a non-linear reference tool;
(A-III) obtaining a first-order partial derivative, A_{i,k}, of Yₖ with respect to an Xᵢ at the base point, where
$${A}_{i , k} = \frac{\partial {Y}_{k}}{\partial {X}_{i}} ; \qquad ( Equation - 1 )$$
(A-IV) optionally obtaining a cross-term partial derivative, C_{p,q,k}, of Yₖ with respect to a pair of two input variables Xᵢ at the base point, obtainable by using the non-linear reference tool, where
$${C}_{p , q , k} = \frac{\partial \frac{\partial {Y}_{k}}{\partial {X}_{p}}}{\partial {X}_{q}} = \frac{\frac{\partial {Y}_{k}}{\partial {X}_{p ( base + h )}} - \frac{\partial {Y}_{k}}{\partial {X}_{p ( base )}}}{{X}_{q ( base + h )} - {X}_{q ( base )}} ; \qquad ( Equation - 2 )$$
where
Xₚ and X_{q} are the pair of two input variables Xᵢ, p and q are positive integers, p≤n, q≤n;
X_{p(base+h)} is value of Xₚ at an alternative point differing from the base point, preferably in the vicinity of the base point;
$$\frac{\partial {Y}_{k}}{\partial {X}_{p ( base + h )}}$$
is first-order partial derivative of Yₖ with respect to Xₚ at the alternative point;
∂Yₖ/∂X_{p(base)} is first-order partial derivative of Yₖ with respect to Xₚ at the base point;
(A-V) optionally obtaining a square-term partial derivative, S_{r,k}, of Yₖ with respect to an input variable Xᵣ, at the base point, where:
$${S}_{r , k} = \frac{{\partial }^{2} {X}_{r}}{\partial {X}_{r}^{2}} = \frac{\frac{\partial {Y}_{k}}{\partial {X}_{r ( base + h )}} - \frac{\partial {Y}_{k}}{\partial {X}_{r ( base )}}}{2 \times ( {X}_{r ( base + h )} - {X}_{r ( base )} )} ; \qquad ( Equation - 3 )$$
where r is a positive integer, and 1≤Xᵣ≤n:
$$\frac{\partial {Y}_{k}}{\partial {X}_{r ( base + h )}}$$
is first-order partial derivative of Yₖ with respect to Xᵣ at the alternative point; and
(A-VI) calculating the value of Yₖ according to the following:
(A-VI.1) where n=1, and step (A-V) is carried out:
$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + Z 0 ; \qquad ( Equation - 4 a )$$
and
(A-VI.2) where n≥2, and
(A-VI.2a) where step (A-IV) is carried out and step (A-V) is optionally carried out:
$${Y}_{k} = {Y}_{k ( base )} + {\sum }_{i = 1}^{u} {A}_{i , k} \times ( {X}_{i} - {X}_{i ( base )} ) + {\sum }_{p = 1}^{v - 1} ( {\sum }_{q = p + 1}^{v} {C}_{p , q , k} \times ( {X}_{p} - {X}_{p ( base )} ) \times ( {X}_{q} - {X}_{q ( base )} ) ) + Z 0 ; \qquad ( Equation - 4 b \text{.1} )$$
or
(A-VI.2b) where step (A-IV) is optionally carried out and step (A-V) is carried out:
$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + Z 0 ; \qquad ( Equation - 4 b \text{.2} )$$
or
(A-VI.2c) where both steps (A-IV) and step (A-V) are carried out:
$${Y}_{k} = {Y}_{k ( base )} + {\sum }_{i = 1}^{u} {A}_{i , k} \times ( {X}_{i} - {X}_{i ( base )} ) + {\sum }_{r = 1}^{w} {S}_{r , k} \times {( {X}_{r} - {X}_{r ( base )} )}^{2} + {\sum }_{p = 1}^{v - 1} ( {\sum }_{q = p + 1}^{v} {C}_{p , q , k} \times ( {X}_{p} - {X}_{p ( base )} ) \times ( {X}_{q} - {X}_{q ( base )} ) ) + Z 0 ; \qquad ( Equation - 4 b \text{.3} )$$
where u, v, and w are positive integers, u≤n, v≤n; and w 5 n; and Z0 is a constant; and
(B) optimizing the industrial system, the industrial process, and/or the industrial product based at least partly on the first set of value of one or more of Yₖ.

16. The process of claim 15, wherein Z0 is zero.

17. The process of claim 15, wherein:
in step (A-VI), case (A-VI.2a), step (A-V) is not carried out; and/or
in step (A-VI), case (A-VI.2b), step (A-IV) is not carried out.

18. The process of claim 15, wherein step (B) comprises:
(B-1) repeating step (A-VI) at one or more alternative set of Xᵢ differing from the first set of Xᵢ, to determine one or more corresponding alternative set of value of the one or more of Yₖ;
(B-2) comparing the first and alternative sets of values of the one or more of Yₖ; and
(B-3) selecting an optimized set of Xᵢ for the industrial system, the industrial process, and/or the industrial product based at least partly on the comparing result in step (B-2).

19. The process of claim 15, wherein:
step (B-1) is performed at least for 1000 times generating at least 1000 corresponding alternative sets of value of the one or more of Yₖ; and
step (B-2) comprises comparing the first and the at least 1000 alternative sets of values of the one or more of Yₖ.

20. The process of claim 15, wherein step (B) comprises:
(B-i) repeating step (A-VI) at one or more alternative set of Xᵢ differing from the first set of Xᵢ, to determine one or more corresponding alternative set of value of the one or more of Yₖ;
(B-ii) calculating a first cost and/or a first profit of the industrial system, the industrial process, and industrial product based on the first set of value of one or more of Yₖ;
(B-iii) calculating an alternative cost and/or an alternative profit of the industrial system, the industrial process, and industrial product based on each of the one or more alternative set of value of the one or more of Yₖ;
(B-iv) comparing the first and alternative cost and/or the first and alternative profit; and
(B-v) selecting an optimized set of Xᵢ for the industrial system, the industrial process, and/or the industrial product based at least partly on the comparing result in step (B-iv).

21. The process of claim 20, wherein:
step (B-i) is performed at least for 1000 times generating at least 1000 corresponding alternative sets of value of the one or more of Yₖ;
step (B-iii) generates at least 1000 alternative cost and/or profit in step (B-ii); and
step (B-iv) comprises comparing the first and the at least 1000 alternative costs and/or profits.

22. The process of claim 15, having at least one of the following features:
(i) the input variables Xᵢ (1≤i≤u), Xₚ (1≤p≤v−1), X_{q} (2≤q≤v), or Xᵣ (1≤r≤w) values are provided in a vector;
(ii) the A_{i,k} values are provided in a matrix;
(iii) the C_{p,q,k} values are provided in a matrix;
(iv) the S_{r,k} values are provided in a matrix;
(v) at least one of the Xᵢ−X_{i(base)}, Xₚ−X_{p(base)}, X_{q}−X_{q(base)} or Xᵣ−X_{r(base)} values is provided in a vector;
(vi) the (Xᵣ−X_{r(base)})² values are provided in a vector; and
(vii) step (A-VI) is carried out using matrix multiplication to calculate output variables Yₖ values and the process further comprises providing the Yₖ values in a vector.

23. The process of claim 15, having at least one of the following features:
(i) the input variables Xᵢ (1≤i≤u), Xₚ (1≤p≤v−1), X_{q} (2≤q≤v), or Xᵣ (1≤r≤w) values are provided in a vector;
(ii) the A_{i,k} values are provided in a matrix;
(iii) the C_{p,q,k} values are provided in a matrix;
(iv) the S_{r,k} values are provided in a matrix;
(v) at least one of the Xᵢ−X_{i(base)}, Xₚ−X_{p(base)}, X_{q}−X_{q(base)} or Xᵣ−X_{r(base)} values is provided in a vector;
(vi) the (Xᵣ−X_{r(base)})² values are provided in a vector; and
(vii) step (A-VI) is carried out using matrix multiplication to calculate output variables Yₖ values and the process further comprises providing the Yₖ values in a vector.

24. The process of claim 21, wherein step (A-II) comprises:
(A-IIa) creating a non-linear reference model of the industrial system, the industrial process, and/or the industrial product by using the non-linear reference tool; and
(A-IIb) obtaining the output value of Y_{k(base)} from the predetermined values of X_{i(base)} using the non-liner reference model.

25. The process of claim 15, wherein u=v=w=n.

26. The process of claim 25, having at least one of the following features:
(i) the n input variables Xᵢ are provided in a vector having n dimensions;
(ii) the A_{i,k} values are provided in a matrix having n×m dimensions;
(iii) the C_{p,q,k} values are provided in a matrix having [n(n−1)]×m dimensions;
(iv) the S_{r,k} values are provided in a matrix having n×m dimensions;
(v) at least one of the Xᵢ−X_{i(base)}, Xₚ−X_{p(base)}, X_{q}−X_{q(base)} or Xᵣ−X_{r(base)} values are provided in a vector having n dimensions;
(vi) the (Xᵣ−X_{r(base)})² values are provided in a vector having n dimensions; and
(vii) step (A-VI) is carried out using matrix multiplication to calculate output variables Yₖ values and the process further comprises providing the Yₖ values in a vector having m dimensions.

27. The process of claim 15, wherein the values of A_{i,k} is obtained using the non-linear reference tool.

28. The process of claim 15, comprising:
creating a non-linear reference model of the industrial system, the industrial process, and/or the industrial product using the non-linear reference tool; and
obtaining the values of A_{i,k} using the non-linear reference model.

29. The process of claim 15, wherein the input variables Xᵢ include at least one of the following:
a unit temperature; a unit pressure; a unit residence time; a quantity of an overall feed mixture; a quantity or a concentration of one or more major component of the feed mixture; a quantity or a concentration of one or more non-negligible contaminant in the feed mixture; a total quantity of catalyst in the reaction; a quantity or concentration of one or more catalytically effective component in the catalyst; a unit energy efficiency; a quantity or concentration of a product in a stream; and a quantity or a concentration of one or more non-negligible contaminant in a product-containing stream.

30. The process of claim 15, wherein the output variables Yₖ include at least one of the following:
an overall quantity or yield of the industrial product; an overall quantity or yield of a byproduct; an overall quantity or yield of an intermediate product; a quantity, a concentration, or a yield of one or more major component of the industrial product; a quantity or a concentration of one or more non-negligible contaminant in the industrial product; a quantity of total energy consumed; a quantity of energy consumed by an individual equipment; metallurgic limitations, capacity limitations; a heat duty of an equipment; and a power consumption of an equipment.

31. The process of claim 15, wherein the industrial system comprises and/or industrial process operates one or more of the following: a feed pre-treatment sub-system; a reactor; a pump; a compressor; an expander; a heat exchanger; a distillation column; a flash drum; a boiler; a furnace; an electric power supply; and a shaft power generator.

32. The process of claim 15, wherein the industrial system comprises and/or the industrial process operates one or more of the following: a crude distillation column; a fluid catalytic converter; a hydroprocessing unit; a reformer; an extraction unit; an adsorption separation unit; a petroleum refinery; a steam cracking furnace; a process gas compressor; a primary fractionation column; a naphtha hydroprocessing unit; an acetylene converter; a refrigeration unit; a cryogenic separation unit; an olefins recovery section; an olefins production plant; and a chemical production plant.

33. The process of claim 15, wherein step (B) comprises optimizing one or more of the following of the industrial system, the industrial process, and/or the industrial product: feed selection; operating conditions; cost; profit; and capacity utilization.
